(19) United States
(12) Patent Application Publication
(10) Pub. No.: US 2014/0222551 A1
(43) Pub. Date: Aug. 7, 2014

(54) ADVERTISING TRACKING AND ALERT SYSTEMS

(71) Applicant: YP Intellectual Property LLC, Tucker, GA (US)

(72) Inventors: Mehul Jain, Foster City, CA (US); William Leslie Theisinger, Los Angeles, CA (US); Karthik Raman, Dublin, CA (US)

(73) Assignee: YP Intellectual Property LLC, Tucker, GA (US)

(21) Appl. No.: 14/173,573

(22) Filed: Feb. 5, 2014

Related U.S. Application Data
(60) Provisional application No. 61/761,145, filed on Feb. 5, 2013.
(60) Provisional application No. 61/761,140, filed on Feb. 5, 2013.

(51) Int. Cl. G06Q 30/02

(52) U.S. Cl. CPC G06Q 30/0246; G06Q 30/0243
USPC 705/14.42; 705/14.45

(57) ABSTRACT

Systems and methods for tracking advertising information and alerting advertisers are disclosed. Consumer activity responsive to first published content relating to an identified advertiser may be monitored. Based on the monitoring, advertisement events corresponding to instances of consumer activity may be identified. Sets of advertising information for the identified advertiser may be processed, the advertising information including information about the advertisement events. The sets of advertising information may be consolidated to form a composite set of advertising information for the identified advertiser. The composite set may be stored in a repository. Advertisement metrics of the composite set may be determined. Authenticated access may be enabled, to the identified advertiser via a network, to the composite set for the identified advertiser. The composite set may be presented via a dashboard view. Indication of the advertisement metrics may be caused, and the advertisement metrics may be presented in the dashboard view.

### CROSS-REFERENCES TO RELATED APPLICATIONS

This application claims the benefit of U.S. Provisional Patent Application No. 61/761,145, filed Feb. 5, 2013, entitled “ADVERTISING ALERT SYSTEM,” and U.S. Provisional Patent Application No. 61/761,140, filed Feb. 5, 2013, entitled “ADVERTISING TRACKING SYSTEM,” the entire disclosures of which are each hereby incorporated by reference for all purposes.

### BACKGROUND

The present disclosure relates in general to advertising, and, more specifically, but not by way of limitation, to advertising tracking systems.

As value, use, access, and demand corresponding to information continue to increase, advertisers demand more of the products and services they use than ever before. Companies are expected to compete to provide greater and greater levels of accuracy and more tailored service offerings. Accessing sources of information that have traditionally been unavailable is now expected. There is a need for advertising services to provide enhanced access to information.

### BRIEF SUMMARY

Certain embodiments of the present disclosure relate generally to advertising, and, more specifically, but not by way of limitation, to advertising tracking systems.

In one aspect, an advertisement information handling system to gather and provide access to advertising information for one or more advertisers is disclosed. One or more network interfaces may be configured to provide access to a network. One or more processors may be coupled to the one or more network interfaces to access advertising information for one or more advertisers through the network, the one or more processors to execute instructions to perform any one or combination of the following. Consumer activity responsive to first published content relating to an identified advertiser may be monitored. Based at least in part on the monitoring, a first advertisement event may be identified, the first advertisement event corresponding to a first instance of consumer activity responsive to the first published content relating to the identified advertiser. Based at least in part on the monitoring, a second advertisement event may be identified, the second advertisement event corresponding to a second instance of consumer activity responsive to the first published content relating to the identified advertiser. A first set of advertising information for the identified advertiser may be processed, the first set of advertising information including information about the first advertisement event. A second set of advertising information for the identified advertiser may be processed, the second set of advertising information including information about the second advertisement event. The first set of advertising information for the identified advertiser and the second set of advertising information for the identified advertiser may be consolidated to form a composite set of advertising information for the identified advertiser. The composite set of advertising information for the identified advertiser may be stored in a repository. One or more advertisement metrics of the composite set of advertising information for the identified advertiser may be determined. To the identified advertiser via a network, authenticated access may be enabled to at least a portion of the composite set of advertising information for the identified advertiser. The at least the portion of the composite set of advertising information may be presented via a dashboard view. Indication of the one or more advertisement metrics of the composite set of advertising information for the identified advertiser may be caused. The one or more advertisement metrics may be presented in the dashboard view. One or more storage media may be coupled to the one or more processors to retain the instructions.

In another aspect, a computer-implemented method for handling advertising information for one or more advertisers is disclosed. Consumer activity responsive to first published content relating to an identified advertiser may be monitored by one or more computing devices. Based at least in part on the monitoring, a first advertisement event may be identified by the one or more computing devices, the first advertisement event corresponding to a first instance of consumer activity responsive to the first published content relating to the identified advertiser. Based at least in part on the monitoring, a second advertisement event may be identified by the one or more computing devices, the second advertisement event corresponding to a second instance of consumer activity responsive to the first published content relating to the identified advertiser. A first set of advertising information for the identified advertiser may be processed by the one or more computing devices, the first set of advertising information including information about the first advertisement event. A second set of advertising information for the identified advertiser may be processed by the one or more computing devices, the second set of advertising information including information about the second advertisement event. The first set of advertising information for the identified advertiser and the second set of advertising information for the identified advertiser may be consolidated by the one or more computing devices to form a composite set of advertising information for the identified advertiser. The composite set of advertising information for the identified advertiser may be stored by the one or more computing devices in a repository. One or more advertisement metrics of the composite set of advertising information for the identified advertiser may be determined by the one or more computing devices. To the identified advertiser via a network, authenticated access may be enabled to at least a portion of the composite set of advertising information for the identified advertiser. The at least the portion of the composite set of advertising information may be presented via a dashboard view. Indication of the one or more advertisement metrics of the composite set of advertising information for the identified advertiser may be caused by the one or more computing devices. The one or more advertisement metrics may be presented in the dashboard view.

In yet another aspect, one or more non-transitory machine-readable media having machine-readable instructions thereon are disclosed, which machine-readable instructions, when executed by one or more computers or other processing devices, implement a method for handling advertising information for one or more advertisers, causing the one or more computers or other processing devices to perform any one or combination of the following. Consumer activity responsive to first published content relating to an identified advertiser may be monitored. Based at least in part on the monitoring, a first advertisement event may be identified, the first advertisement event corresponding to a first instance of consumer activity responsive to the first published content relating to the identified advertiser. Based at least in part on the monitoring, a second advertisement event may be identified, the second advertisement event corresponding to a second instance of consumer activity responsive to the first published content relating to the identified advertiser. A first set of advertising information for the identified advertiser may be processed, the first set of advertising information including information about the first advertisement event. A second set of advertising information for the identified advertiser may be processed, the second set of advertising information including information about the second advertisement event. The first set of advertising information for the identified advertiser and the second set of advertising information for the identified advertiser may be consolidated to form a composite set of advertising information for the identified advertiser. The composite set of advertising information for the identified advertiser may be stored in a repository. One or more advertisement metrics of the composite set of advertising information for the identified advertiser may be determined. To the identified advertiser via a network, authenticated access may be enabled to at least a portion of the composite set of advertising information for the identified advertiser. The at least the portion of the composite set of advertising information may be presented via a dashboard view. Indication of the one or more advertisement metrics of the composite set of advertising information for the identified advertiser may be caused. The one or more advertisement metrics may be presented in the dashboard view.

In some embodiments, the first published content relating to the identified advertiser may be published by a first publisher. Consumer activity responsive to second published content relating to the identified advertiser may be monitored. The second published content relating to the identified advertiser may be published by a second publisher. Based at least in part on the monitoring, a third advertisement event may be identified, the third advertisement event corresponding to an instance of consumer activity responsive to the second published content relating to the identified advertiser. A third set of advertising information for the identified advertiser may be processed, the third set of advertising information including information about the third advertisement event. The third set of advertising information for the identified advertiser may be consolidated into the composite set of advertising information for the identified advertiser. One or more additional advertisement metrics of the composite set of advertising information for the identified advertiser may be determined. Indication of the one or more additional advertisement metrics of the composite set of advertising information for the identified advertiser may be caused, where the one or more additional advertisement metrics are to be presented in the dashboard view.

In some embodiments, one or more items of the composite set of advertising information for the identified advertiser may be compared to reference advertising information. One or more conditions may be identified at least partially based on the comparison. A notification profile retained for the identified advertiser may be accessed. A notification corresponding to the identified advertiser may be sent. The notification may be at least partially based on the one or more conditions and the notification profile for the identified advertiser.

In some embodiments, one or more items of the composite set of advertising information for the identified advertiser may be compared to reference advertising information that comprises information about a set of one or more peer advertisers and/or information about a set of one or more publishers. One or more conditions may be identified at least partially based on the comparison. A recommendation for the identified advertiser may be identified based at least in part on the one or more conditions. Indication of the recommendation to the identified advertiser may be caused.

In some embodiments, one or both of the first advertisement event and/or the second advertisement event may correspond to one or more of a display, a consumer communication, a consumer selection, a consumer review, a consumer rating, a consumer preference indication, and/or a conversion of a consumer to a client relationship with the identified advertiser.

In some embodiments, the identified advertiser may be associated with an advertiser category. A set of one or more peer advertisers associated with the advertiser category may be identified. The one or more advertisement metrics of the composite set of advertising information for the identified advertiser are with reference to one or more advertisement metrics of advertising information for the set of one or more peer advertisers.

In some embodiments, one or more submissions from the identified advertiser may be processed, the one or more submissions at least partially defining advertising content to be directed to a set of one or more publishers for publication. The advertising content may be transmitted over a network to the set of one or more publishers, and the set of one or more publishers may be caused to publish the advertising content.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures.

FIG. 1 depicts a high-level block diagram of a system, in accordance with certain embodiments of the present disclosure.

FIG. 2 depicts a high-level block diagram of a system, in accordance with certain embodiments of the present disclosure.

FIG. 3 depicts a functional block diagram of a mobile computing device, in accordance with certain embodiments of the present disclosure.

FIG. 4 depicts a functional block diagram of a system for call handling, in accordance with certain embodiments of the present disclosure.

FIG. 5 depicts a functional block diagram of a system for call handling, in accordance with certain embodiments of the present disclosure.

FIG. 6 depicts a functional block diagram of certain aspects of an advertising information handling system that may be or include an advertising platform, in accordance with certain embodiments of the present disclosure.

FIG. 7 illustrates one embodiment of an advertiser interface for an advertising platform, in accordance with certain embodiments of the present disclosure.

FIGS. 8A, 8B, 8C, 8D, 8E, 8F, 8G, and 8H are screenshots illustrating non-limiting advertiser interface examples, in accordance with certain embodiments of the present disclosure.

FIG. 9 illustrates a simplified functional block diagram of a notification subsystem for an advertiser alert system, in accordance with certain embodiments of the present disclosure.

FIG. 10 illustrates a method for identifying notifications relating to an advertisers account, in accordance with certain embodiments of the present disclosure.

FIG. 11 illustrates a method for identifying recommendations for an advertiser, in accordance with certain embodiments of the present disclosure.

FIG. 12 illustrates an example method, in accordance with certain embodiments of the present disclosure.

FIG. 13 depicts a block diagram of an embodiment of a computer system, in accordance with certain embodiments of the present disclosure.

FIG. 14 depicts a block diagram of an embodiment of a special-purpose computer system, in accordance with certain embodiments of the present disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment of the disclosure. It should be understood that various changes may be made in the function and arrangement of elements without departing from the spirit and scope of the disclosure as set forth in the appended claims.

Specific details are given in the following description to provide a thorough understanding of the embodiments. However, it will be understood by one of ordinary skill in the art that the embodiments maybe practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Certain embodiments may provide an advertiser platform that may track advertising. Certain embodiments may display business-valuable information in real time for viewing by an advertiser. As used herein, an advertiser may correspond to (and may be variously referenced herein by) any one or combination of a merchant, a business, an advisor, a representative, a provider, a service provider, a product provider, and/or the like in various embodiments. Data from the tracked advertising may be harvested in one or more feeds provided via the platform. The one or more feeds could be real-time feeds in some embodiments. The one or more feeds may help advertisers understand various business-valuable aspects related to their advertising, such as customer responses to advertisements, call tracking, data from publisher's/advertiser's sites, and/or the like.

In various embodiments, an advertiser platform may track calls, messages, billing, etc. and enable advertisers to interact with the platform to retrieve, see, and use the data. A feed of information and/or a dashboard could be in a web portal and/or provided via a mobile application. Data mining can enable the advertisers to discover undercurrents of advertising data. Follow-up could be linked such as calling customers or viewing more detailed reports. The salesperson can customize the dashboard and/or the feeds and what can be ignored, although default templates may be supplied. With certain embodiments, a mobile application may be made available for execution on a mobile computing device to provide various features described herein. Various embodiments may include a specific purpose-based mobile application or a mobile application integrated with various other mobile application features.

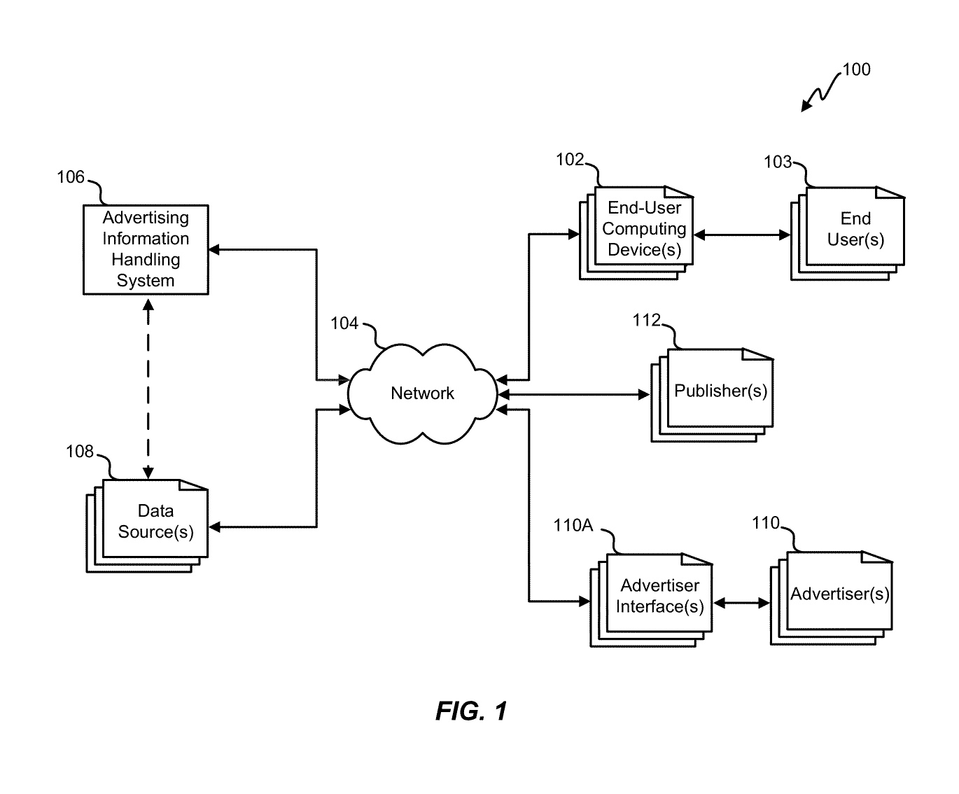

Various embodiments will now be discussed in greater detail with reference to the accompanying figures, beginning with FIG. 1.

FIG. 1 depicts a high-level block diagram of a system 100, in accordance with certain embodiments of the present disclosure. The system 100 allows for interaction between two or more of computing device(s) 102, end user(s) 103, advertiser(s) 110, publisher(s) 112, an advertising information handling system 106, and/or data source(s) 108. As depicted, various elements of the system 100 may be communicatively coupled or couplable to a network 104.

The network 104 may be any suitable means to facilitate data transfer in the system 100. In various embodiments, the network 104 may be implemented with, without limitation, one or more of the Internet, a wide area network (WAN), a local area network (LAN), a wireless local area network (WLAN), a metropolitan area network (MAN), a cellular network, such as through 4G, 3G, GSM, etc., another wireless network, a gateway, a conventional telephone network, or any other appropriate architecture or system that facilitates the communication of signals, data, and/or message. The network 104 may transmit data using any suitable communication protocol. The network 104 and its various components may be implemented using hardware, software, and communications media such wires, optical fibers, microwaves, radio waves, and other electromagnetic and/or optical carriers; and/or any combination of the foregoing. The computing device(s) 102, end user(s) 103, advertiser(s) 110, publisher(s) 112, an advertising handling system 106, and/or data source(s) 108 may be communicatively coupled or couplable to the network 104 via any suitable communication paths that support the communication protocol(s) used in the various embodiments.

The advertising information handling system 106 may facilitate searching of one or more information repositories in response to information received over the network 104 from the computing devices 102. In various embodiments, the advertising information handling system 106 may include any device or set of devices configured to process, send, receive, retrieve, detect, generate, compute, organize, categorize, qualify, store, display, present, handle, or use any form of information and/or data suitable for the embodiments described herein.

The advertising information handling system 106 may include a single computing device or multiple computing devices, which, in some embodiments, may be implemented in or with a distributed computing and/or cloud computing environment. The advertising information handling system 106 may include one or more processing resources communicatively coupled to one or more storage media, random access memory (RAM), read-only memory (ROM), and/or other types of memory. The advertising information handling system 106 may include any one or combination of various input and output (I/O) devices, network ports, and display devices.

In certain embodiments, the advertising information handling system 106 may be communicatively coupled or couplable to one or more data sources 108. The one or more data sources 108 may include any suitable source of data. In various embodiments, the one or more data sources 108 may include one or more of a database, a website, any repository of data in any suitable form, and/or a third party. With some embodiments, the data sources 108 may include one or more mobile computing device locator services that provide information regarding the location of one or more computing devices 102. With some embodiments, the data sources 108 may provide various details relating to call data. With some embodiments, the data sources 108 may provide caller name information from calling name delivery (CNAM), also known as caller identification or caller ID, may be used to determine particular details about the caller. With some embodiments, the data sources 108 may provide information about the area of a caller. With some embodiments, the data sources 108 may provide demographic data about an area.

In various embodiments, the data from the one or more data sources 108 may be retrieved and/or received by the advertising information handling system 106 via the network 104 and/or through any other suitable means of transferring data. For example, in some embodiments, the advertising information handling system 106 and the data sources 108 could use any suitable means for direct communication, as depicted.

According to certain embodiments, data may be actively gathered and/or pulled from one or more data sources 108, for example, by accessing a third party repository and/or by “crawling” various repositories. With some embodiments, the data pulled and/or pushed from the one or more data sources 108 may be made available by the advertising information handling system 106 for user(s) 103 of the computing device(s) 102. In alternative embodiments, data from the one or more data sources 108 may be made available directly to the computing device(s) 102.

According to certain embodiments, the advertising information handling system 106 may be or include an advertising platform. The advertiser(s) 110 may access the advertising information handling system 106 via advertiser interface(s) 110A. In various embodiments, the advertiser interface(s) 110A may include any suitable input/output module or other system/device operable to serve as an interface between the advertiser(s) 110 and the advertising platform. In some embodiments, an advertiser interface 110A may include an application programming interface (API). In some embodiments, an advertiser interface 110A may include a web interface. The advertiser interface 110A may cause a web page to be displayed on a browser of an advertiser 110. The advertiser interface 110A may allow for transfer of and access to advertising information in accordance with certain embodiments disclosed herein. Accordingly, the advertising information handling system 106 may have web site/portals giving access to such information. The advertiser interface(s) 110A may facilitate communication over the network 104 using any suitable transmission protocol and/or standard. In some embodiments, the advertising information handling system 106 may include and/or provide the advertiser interface(s) 110A, for example, by making available one or more of a website, a web page, a web portal, a web application, a mobile application, enterprise software, and/or any suitable application software.

In certain embodiments, an advertiser interface 110A may include a computing device of an advertiser 110. In certain embodiments, an advertiser interface 110A may include a mobile computing device that may be any portable device suitable for sending and receiving information over a network in accordance with embodiments described herein. For example without limitation, in various embodiments, the mobile computing device may include one or more devices variously referenced as a mobile phone, a cellular telephone, a smartphone, a handheld mobile device, a tablet computer, a web pad, a personal digital assistant (PDA), a notebook computer, a handheld computer, a laptop computer, or the like.

In some embodiments, the advertising information handling system 106 may provide for the selection and provision of advertisements to one or more of end-user computing devices 102, end users 103, and/or publishers 112. In certain embodiments, one or more advertisers 110 may have advertisements that may be placed in a web page made available to one or more computing devices 102. In certain embodiments, one or more advertisers 110 may have advertisements that may be displayed with an application made available to one or more computing devices 102, such as a mobile application. The placement of the advertisements may be in accordance with one or more paid placement arrangements and one or more advertising models.

Advertisements may be included in a results page responsive to a keyword search initiated by an end user 103. The search may be performed by an online search engine facilitated by the advertising information handling system 106. An advertisement of an advertiser 110 may be included within a results page with results identified and/or compiled by the search engine and sent via the network 104 to the computing device 102 of the end user 103 that initiated the search. The inclusion and/or placed of the advertisement may be based on a paid placement model and/or paid inclusion model.

Advertisements may be provided for a publisher's website or other media channel. The publishers 112 may then publish advertising content that can be accessed by end users 103. The publishers 112 may include websites, social media sites, networking sites, review sites, various for a, and/or the like. The publishers 112 may use, facilitate, and/or provide any of various types of media channels. For example, the media channels may correspond to one or more of web, mobile, social, video, television, and/or the like.

In some embodiments, the publishers 112 may access the advertising information handling system 106 via an application programming interface (API). In some embodiments, the publishers 112 may request one or more advertisements from the advertising information handling system 106. In some embodiments, the requests may correspond to a search query from an end user 103. The publishers 112 may allow interaction with content through an API. For example, a merchant corresponding to an advertiser 110 could interact with an end user 103 through a publisher 112.

In some embodiments, advertisers 110 and computing devices 102 may communicate via Voice Over Internet Protocol (VoIP) technology. An end user 103 and an advertiser 110 may be communicatively coupled through switches of the network 104, which may include switches of a public telephone network in some embodiments. In some embodiments, one or more advertisers 110 could be contacted by an end user 103 and/or the advertising information handling system 106 via various media channels, such as email, chat, instant message, etc.

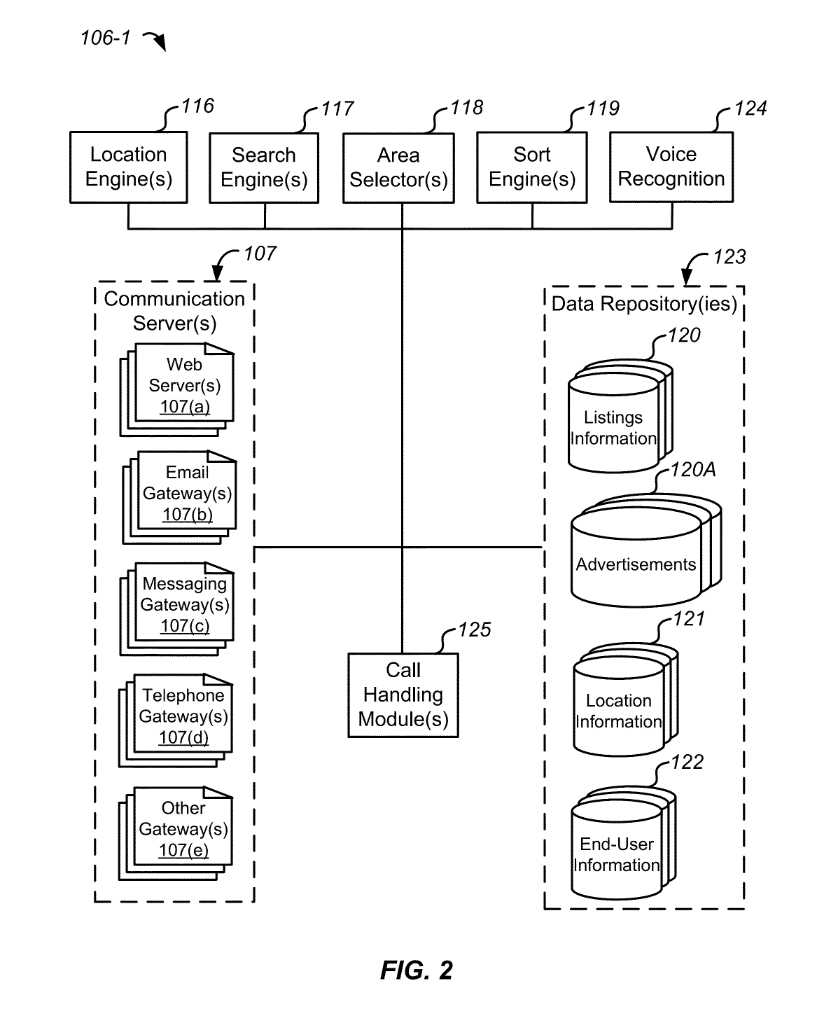

FIG. 2 shows a high-level block diagram of an advertising handling system 106-1, in accordance with certain embodiments of the present disclosure. The advertising handling system 106-1 may correspond to the advertising handling system 106 of FIG. 1, but one embodiment of the advertising information handling system 106 is shown in more detail. While engines, repositories, and other components are described separately herein, it should be appreciated that the components may be combined and/or implemented differently in any combination to provide certain features in various embodiments. In various embodiments, different processes running on one or more shared computers may implement some of the components.

As depicted in FIG. 2, the advertising information handling system 106-1 may include one or more communication servers 107. The one or more communication servers 107 may include one or more web servers 107(a), one or more email gateways 107(b), one or more instant messaging gateways 107(c), one or more telephone gateways 107(d), one or more other gateways 107(e), such as television gateways, and/or one or more other types of servers, such as an application gateway (not shown) to interface with different servers. Some embodiments may use one type of communication server 107, such as a web server 107(a), to receive search requests and another type of communication server 107 to provide the search results. Some embodiments may use different types of communication servers 107 to service different types of computing devices 102.

In some embodiments, a web server 107(a) may communicate with a computing device 102 via HyperText Transfer Protocol (HTTP) and/or other types of communication protocols, such as File Transfer Protocol (FTP), Wireless Application Protocol (WAP), etc. A web server 107(a) may provide static web pages, dynamic web pages, and/or web services.

In some embodiments, a web server 107(a) may provide web applications to a computing device 102 for execution in a web browser running on the computing device 102; and the web applications may include scripts for execution within an isolated environment in a browser. In some embodiments, the web server 107(a) may provide rich-client applications to the computing device 102; and the rich-client application may be programmed to have access to functions of the operating system running on the computing device 102.

In some embodiments, the communication servers 107 provide a user interface for user interaction with listings. For example, the web servers 107(a) may provide a user interface via static web pages, dynamic web pages, and/or web services, etc. For example, the web servers 107(a) may provide the listings 120 with links to detail information pages of the listings 120, such as a map, business hours, driving directions, etc. The web servers 107(a) may provide user interfaces for the users to rate the listings 120, provide reviews, view reviews from other users, etc. The web servers 107(a) may provide user interfaces to make reservations or to make purchases via the listings 120. The web servers 107(a) can track various different types of user interactions with the listings to determine or estimate the level of user interest in the listings. The web servers 107(a) may provide rich client applications for execution in the mobile computing device to provide the user interfaces. The communications server(s) 107 may be communicatively coupled to one or more of a location engine(s) 116, a search engine(s) 117, an area selector(s) 118, and/or a sort engine(s) 119 to process the search request and present search results based on the information stored in one or more data repositories 123.

In some embodiments, the one or more data repositories 123 may include listings information 120 about business entities or public end-user information, or other types of searchable end-user information. The one or more listings information repositories 120 may retain any local listings information suitable for embodiments of this disclosure, such as business, product, and service information. In certain embodiments, the local listings information may correspond to directory information of the kind available via Yellow Pages services and the like. The listings 120 may include addresses, telephone numbers, advertisements, announcements, and/or end-user information, etc.

In some embodiments, advertisement units may be stored in one or more advertisement repositories 120A. The advertisement units may correspond to any of various types of advertisement products. For example, the advertisement units may correspond to one or more of subscription advertisements, pay-per-call advertisements, presence advertisements, cost-per-click advertisements, cost-per-impression advertisements, display advertisements, and/or the like. The advertisement units may correspond to any of various types of media. For example, the advertisement units may correspond to one or more of web, mobile, social, video, and/or the like.

Listings 120 and/or advertisements 120A of businesses or people, such as restaurants, car dealers, retailer locations, advertisers, gas stations, parking lots, plumbers, and the like, may have street addresses or other location parameters, such as longitude and latitude coordinates, stored as locations in one or more location information repositories 121. Thus, the listings 120 may be associated with locations 121. The locations 121 may be part of the listings 120, or associated with the listings 120. In some embodiments, the listings 120 include information related to business entities at corresponding locations 121. The entities may be businesses or people. Some of the entities may be advertisers who pay advertisement fees to promote their listings 120. Some of the entities may be non-advertisers who have free listings 120. In some embodiments, the listings 120 may be accessible to the public or to registered members.

In some embodiments, the data repository(ies) 123 may include one or more end-user information repositories 122. In some embodiments, a computing device 102 may store end-user information 122. In some embodiments, both the computing device 102 and the online data repository(ies) 123 store the end-user information 122 for a particular end user 103. In some embodiments, when there is a data communication connection between the computing device 102 and the online data repository(ies) 123, the computing device 102 and the online data repository(ies) 123 may synchronize their copies of the end-user information 122 for the end user 103. The end-user information 122 may be associated with the corresponding end users 103. In some embodiments, an end user 103 may create corresponding end-user information 122. The web servers 107(a) may generally limit the access to the end-user information 122 to those who created the corresponding end-user information 122.

In various embodiments, the data repository(ies) 123 may be implemented in various ways. For example, one or more data processing systems may store the information about the listings 120, advertisements 120A, the locations 121, and the end-user information 122. For example, one or more relational or object-oriented databases, or flat files on one or more computers or networked storage devices, may store the information about the listings 120, the advertisements 120A, the locations 121, and the end-user information 122. In some embodiments, a centralized system stores the information about the listings 120, the advertisements 120A, the locations 121, and the end-user information 122; alternatively, a distributed/cloud system, network-based system, such as being implemented with a peer-to-peer network, or Internet, may store the information about the listings 120, the advertisements 120A, the locations 121, and the end-user information 122.

The advertising information handling system 106 may include one or more processors communicatively coupled to one or more memories. The advertising information handling system 106 may include one or more network interfaces communicatively coupled to one or more processors. The one or more network interfaces may include any suitable input/output module(s) or other system(s)/device(s) operable to serve as one or more interfaces between the advertising information handling system 106 and the network 104. The advertising information handling system 106 may use the one or more network interfaces to communicate over the network 104 using any suitable transmission protocol(s) and/or standard(s).

The advertising information handling system 106 may include one or more call handling modules 125. The call handling module(s) 125 may be configured to one or more of decode, route, and redirect calls from end users to advertisers. Aspects of the call handling module(s) 125 are further discussed herein.

In various embodiments, one or more of the location engine 116, the search engine 117, the area selector 118, the sort engine 119, the call handling module(s) 125, and/or other modules, such as the voice recognition system 124 and/or other modules disclosed herein, may be stored in the one or more memories and may include one or more software applications, executable with the processors, for receiving and processing data requests. In some embodiments, one or more of the location engine 116, the search engine 117, the area selector 118, the sort engine 119, the call handling module(s) 125, and/or other modules, such as the voice recognition system 124 and/or other modules disclosed herein, may be servers communicating with the communication server(s) 107. The server communication may be over a network, such as a local area network, a wide area network, an intranet, Internet, and/or the like. Any one or combination of the various servers may run on common or separate computers. In some embodiments, there may be one or more layers of application servers between the communication server 107 and the data repository(ies) 123 to process the business logic and data access of the rich client applications. Alternatively, application servers may be integrated with the communication servers 107, such as the web servers 107(a). Certain embodiments are not limited to a particular type of connections among the communication servers 107, the location engine 116, the search engine 117, the area selector 118, the sort engine 119, the data repository(ies) 123, and/or other modules.

In some embodiments, one computer system implements one or more of the components of the system 106. Alternatively, different processes running on one or more shared computers may implement some of the components. For example, one computing module, thread, or process may implement multiple of the components. In some embodiments, special purpose data processing systems implement the one or more of the components. In some embodiments, processes running according to software instructions on general purpose data processing systems, such as general purpose personal computers or server computers, can implement the components. Thus, the implementations are not limited to particular hardware, software, or particular combinations of hardware and software.

One or more of the location engine 116, the search engine 117, the area selector 118, the sort engine 119, and/or other modules may be configured to perform any of the steps of methods described in the present disclosure. In some embodiments, the location engine(s) 116 may include one or more engines and may use GPS coordinates, cellular tower triangulation techniques, Wi-Fi-based location information, carrier-provided location information, and/or other location determination systems to identify a location of the computing device 102. In some embodiments, the location engine 116 determines a location of interest to the end user 103 related to a search request. In some embodiments, the location engine 116 determines a location of interest to the end user 103 related to a phone call initiated with the computing device 102. The location of interest may be based on a location of the computing device 102. In some embodiments, the end user 103 may explicitly specify the location of interest in a search request; and the location engine 116 extracts the location of interest from the search request. In some embodiments, a location of interest may be based on end-user information 122 stored for a particular end user 103 and associated with identification information of the end user 103 or the computing device 102. In some embodiments, the end user 103 may specify some or all of the end-user information 122.

In some embodiments, the location engine 116 may automatically identify the location of interest based on determining the current location of the computing device 102 that is used to submit a search request and/or initiate a phone call. For example, the location engine 116 may determine the location of the computing device 102 based on a connection point the computing device 102 used to access the network 104 (e.g., based on the location of a wireless network access point, a base station of a cellular communication system, or a connection point to a wired network). In some embodiments, the computing device 102 automatically determines its current position (e.g., via a satellite positioning system, or a cellular positioning system) and transmits the determined or estimated position to the web server 107(a) with the search request, or provides the position in response to a request from the location engine 116.

In some embodiments, the search engine 117 may retrieve listings 120 from the data repository(ies) 123 according to a search request and/or a phone call. The sort engine 119 may rank the listings 120 in the search results according to the distance between the location of interest and the locations 121 of the listings 120, or according to current levels of user interest in the retrieved listings 120. The web servers 107(a) may track various different types of user interactions with the listings 120 to determine or estimate the level of user interest in the listings 120. The sort engine 119 may rank the listings 120 according to other criteria, in accordance with other embodiments described herein. In various embodiments, the search engine 117 may be configured to search for and/or correlate user data, advertiser data, location data, and/or other data, in accordance with various embodiments described herein.

In various embodiments, the area selector 118 may be configured to select areas of interest and/or identify hot spots per heat mapping, in accordance with various embodiments described herein. In some embodiments, the area selector 118 may select a first geographic area based on the location of interest identified by the location engine 116. The search engine 117 may then retrieve a first set of listings 120 that have locations 121 within the selected first geographic area and that satisfies the search criteria. In some embodiments, the search engine 117 may search for listings 120 in a target area to obtain a set of search results; the area selector 118 may select geographic areas and selects groups of results that are within the selected geographic areas respectively.

The computing device 102 may be any data processing device suitable for embodiments disclosed herein. In various embodiments, the computing device 102 could be one or more of a notebook computer, a personal computer, a workstation, a network computer, a personal digital assistant (PDA), a mobile phone, a cellular phone, a television set with or without a set-top box, a game console, an electronic kiosk, microprocessor-based or programmable consumer electronics, and/or the like. Some embodiments include a landline phone that may not be a computing device. In some embodiments, the computing device 102 includes a web browser which allows the end user 103 to submit a search request to one of the web servers 107(a) for location dependent information, such as a listing 122 of businesses or people, such as restaurants, car dealers, retailer locations, advertisers, gas stations, parking lots, plumbers, and/or the like. Alternatively, the computing device 102 may provide the search request via other channels, such as email, short message service (SMS), instant messaging (IM), telephone connection, etc. For example, the computing device 102 may provide the search request to an email gateway 107(b) via email, or to an IM gateway 107(c) via instant messaging, or to a telephone gateway 107(c) via a telephone call. Some embodiments may use other types of gateways. Thus, the disclosure is not limited to the examples or combinations illustrated.

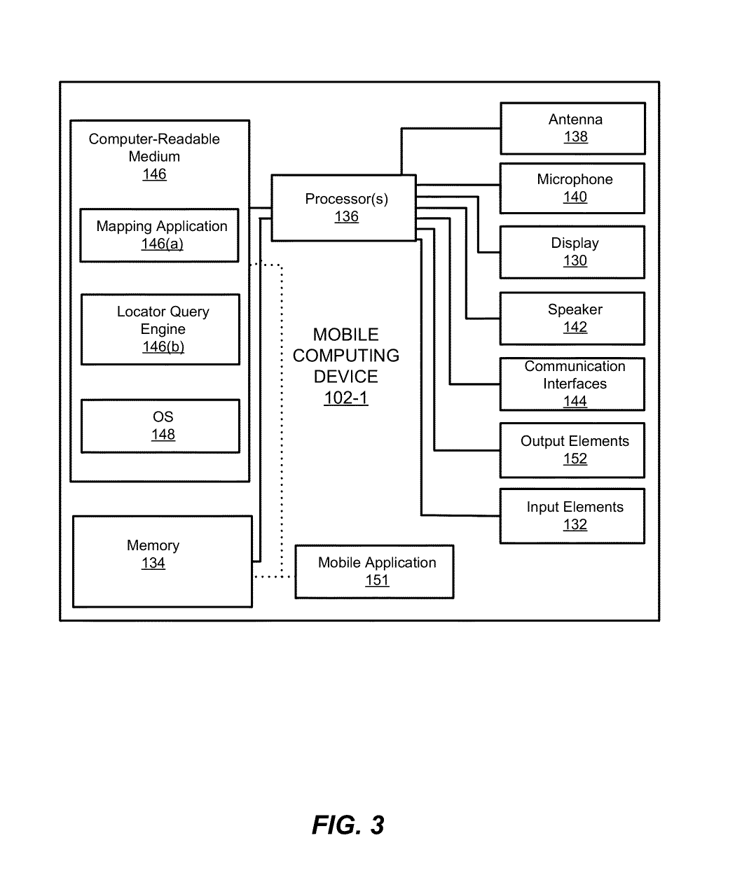

FIG. 3 is a functional block diagram of a computing device 102-1, which may be a mobile computing device 102-1, in accordance with certain embodiments of the present disclosure. In some embodiments, the mobile computing device 102 may be provided with a mobile application 151 configured to run on the mobile computing device 102 and transform the mobile computing device 102 into a local guide to facilitate communications with advertisers at least partially based on location. In some embodiments, the mobile computing device 102 may correspond to an advertiser interface 110A. The mobile computing device 102 may facilitate an advertiser interface 110A at least in part with the advertising platform of the advertising information handling system 106. In some embodiments, the mobile computing device 102 may be provided with a mobile application 151 or other application configured to run on the mobile computing device 102 and transform the mobile computing device 102 into an advertiser interface 110A with the advertising platform of the advertising information handling system 106.

The mobile computing device 102 may be any portable device suitable for sending and receiving information over a network in accordance with embodiments described herein. For example without limitation, in various embodiments, the mobile computing device 102 may include one or more variously referenced as a mobile phone, a cellular telephone, a smartphone, a handheld mobile device, a tablet computer, a web pad, a PDA, a notebook computer, a handheld computer, a laptop computer, a vehicle computer, and/or the like.

As shown in FIG. 3, the mobile computing device 102 includes a display 130 and input elements 132 to allow a user to input information into the computing device 102. By way of example without limitation, the input elements 132 may include one or more of a keypad, a trackball, a touchscreen, a touchpad, a pointing device, a microphone, a voice recognition device, or any other appropriate mechanism for the user to provide input. The mobile computing device 102 includes a memory 134 communicatively coupled to one or more processors 136 (e.g., a microprocessor) for processing the functions of the mobile computing device 102. The mobile computing device 102 may include at least one antenna 138 for wireless data transfer.

The mobile computing device 102 may also include a microphone 140 to allow a user to transmit his/her voice through the mobile computing device 102, and a speaker 142 to allow the user to hear voice communication, music, etc. In addition, the mobile computing device 102 may include one or more interfaces in addition to the antenna 138, e.g., a wireless interface coupled to an antenna. The communications interfaces 144 can provide a near field communication interface (e.g., contactless interface, Bluetooth, optical interface, etc.) and/or wireless communications interfaces capable of communicating through a cellular network, such as GSM, or through Wi-Fi, such as with a wireless local area network (WLAN). Accordingly, the computing device 102 may be capable of transmitting and receiving information wirelessly through both short range, radio frequency (RF) and cellular and Wi-Fi connections.

Additionally, the mobile computing device 102 can be capable of communicating with a GPS in order to determine to location of the mobile computing device 102. The antenna 138 may include a cellular antenna (e.g., for sending and receiving cellular voice and data communication, such as through a network such as a 3G or 4G network), and interfaces 144 may include one or more local communication interfaces. The antenna 138 may include GPS receiver functionality. In other embodiments contemplated herein, communication with the mobile computing device 102 may be conducted with a single antenna configured for multiple purposes (e.g., cellular, transactions, GPS, etc.), or with further interfaces (e.g., three, four, or more separate interfaces).

The mobile computing device 102 can also include one or more computer-readable media 146 coupled to the processor(s) 136, which stores application programs and other computer code instructions for operating the device, such as an operating system (OS) 148. The mobile application 151 may be stored in the memory 134 and/or computer-readable media 146. The computer-readable medium 146 can include a mapping application.

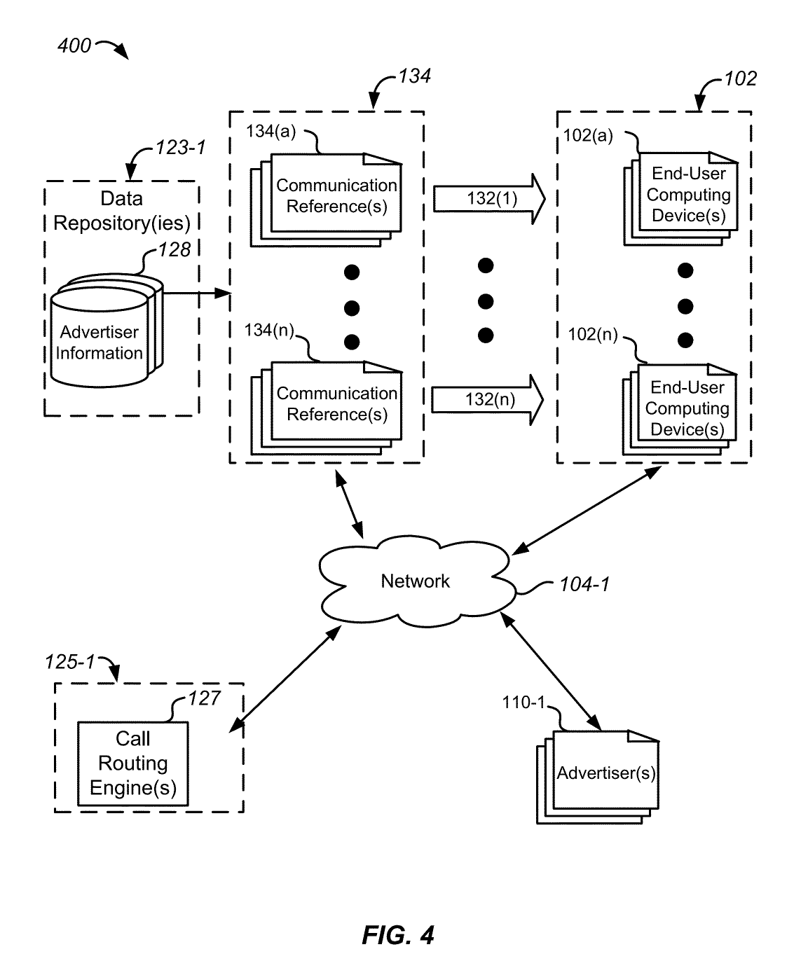

FIG. 4 shows a diagram of a system 400 for call handling, in accordance with certain embodiments of the present disclosure. The system 400 may correspond to certain embodiments addressed with respect to other figures herein. The system 400 may include one or more data repositories 123-1. The one or more data repositories 123-1 may correspond to the data repositories 123 of FIG. 2 in some embodiments. In some embodiments, the one or more data repositories 123-1 may include one or more advertiser information repositories 128. In some embodiments, the advertiser contact information repositories 128 may correspond to the listings information repositories of FIG. 2. The advertiser information repository 128 may contain phone numbers of target phones. Typically, the target phones belong to advertisers, which may correspond to one or more of institutions, businesses, individuals, etc. that seek publicity through various media channels 132, such as web servers, WAP servers, short messaging services, etc., which may or may not use the network 104-1.

In some embodiments, communication references 134 may be provided to the end-user computing devices 102. The communication references 134 may allow routing of calls from end-user devices at least partially based on location in accordance with certain embodiments of this disclosure. In various embodiments, the communication references 134 may be delivered with content information (e.g., web page, WAP page, short message, television programs, news articles, etc.) to end-user computing devices 102. In some embodiments, a communication reference 134 may be a phone number. The phone number may correspond to a set of advertisers. The phone number could indicate a category of advertisers. In some embodiments, a communication reference 134 may facilitate a click-to-call feature. In some embodiments, communication reference 134 may be an encoded target phone number. Encoded target phone numbers may allow the association of additional information with the target phone numbers, such as the media channels used, special promotions, etc.

In embodiments where an end-user computing device 102 is a mobile device, content information, including advertisements, may be transferred to the device through wireless communication connections, such as cellular communication links, wireless access points for wireless local area network, etc. In some embodiments, an end-user computing device 102 can receive content information from multiple types of media channels 132 (e.g., a web server, a WAP server, a SMSC, etc.). In some embodiments, an end-user computing device 102 may be able to initiate a phone call (e.g., automatically dialing according to the encoded phone number embedded in the content information when a user selects the number). Alternatively, a user may dial a phone call using another phone, separate from the end-user computing device 102.

In some embodiments, dialing at least a portion of a phone number corresponding to a communication reference 134 may connect the phone call to a call handling module 125-1. The call handling module 125-1 may include one or more call routing engines 127. The call routing engine 127 may include one or both of a router and a decoder. In some embodiments, based at least partially on the communication reference selected, such as a phone number dialed and/or a call button selected, the call routing engine 127 may determine one or more corresponding target communication references using the advertiser information repository 128 and may connect the phone call to one or more target advertisers 110-1 through the network 104-1.

The network 104-1 may correspond to the network 104 in some embodiments. In some embodiments, the network 104-1 be or include a telephone network. In some embodiments, a telephone network 104-1 may overlap at least a portion of the network 104. The telephone network 104-1 may be circuit switched, package switched, or partially circuit switched and partially package switched. For example, the telephone network may partially use the Internet to carry the phone call (e.g., through VoIP). For example, a connection between an end-user device 102 and the call routing engine 127 may be carried using VoIP; and the connection between a router and a decoder of the call routing engine 127 may be carried using a land-line based, circuit-switched telephone network.

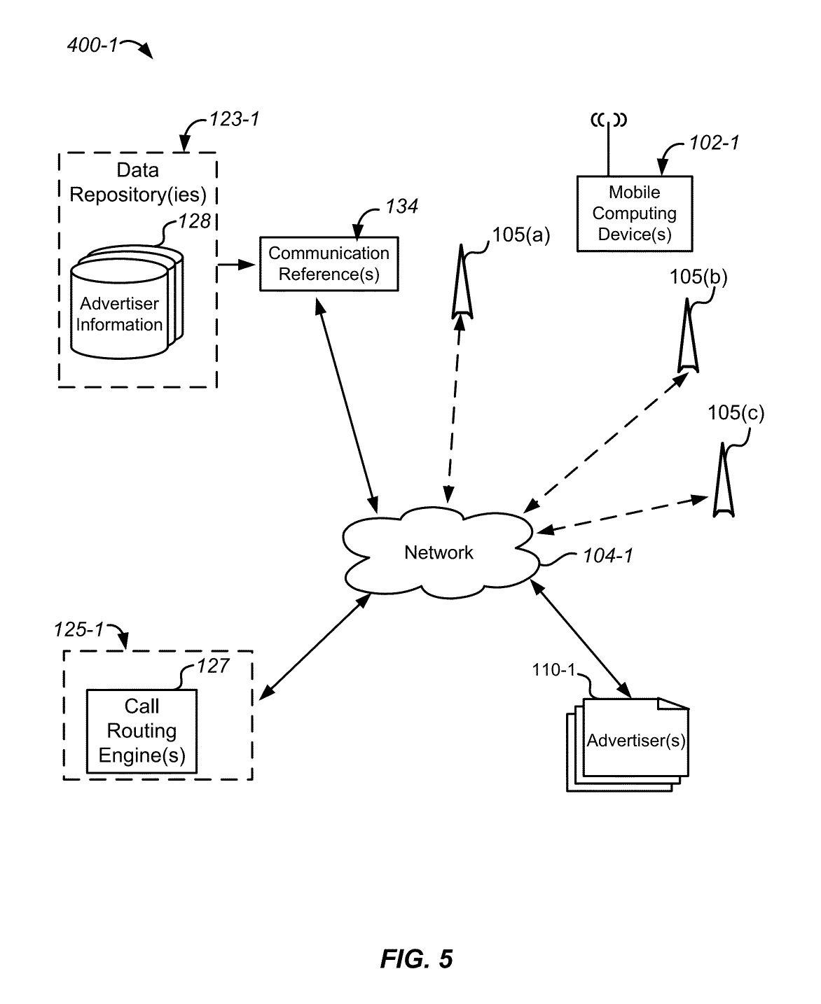

FIG. 5 shows a diagram of a system 400-1 for call handling, in accordance with certain embodiments of the present disclosure. The system 400-1 may correspond to the system 400 for certain embodiments where the end-user computing devices 102 are mobile computing devices 102-1. The mobile computing device(s) 102-1 may access the network 104-1 through a wireless link to an access point. For example, the mobile computing device(s) 102-1 may access the network 104-1 through one or more of access point 105(a), access point 105(b), access point 105(c), and/or any other suitable access point(s).

The access points 105 may be of any suitable type or types. For example, an access point 105 may be a cellular base station, an access point for wireless local area network (e.g., a WiFi access point), an access point for wireless personal area network (e.g., a Bluetooth access point), etc. The access point 105 may connect the mobile computing device 102 to the network 104-1, which may include the Internet, an intranet, a local area network, a public switched telephone network (PSTN), private communication networks, etc. In some embodiments, access point(s) may be used in obtaining location information for the mobile computing device 102, as described further herein.

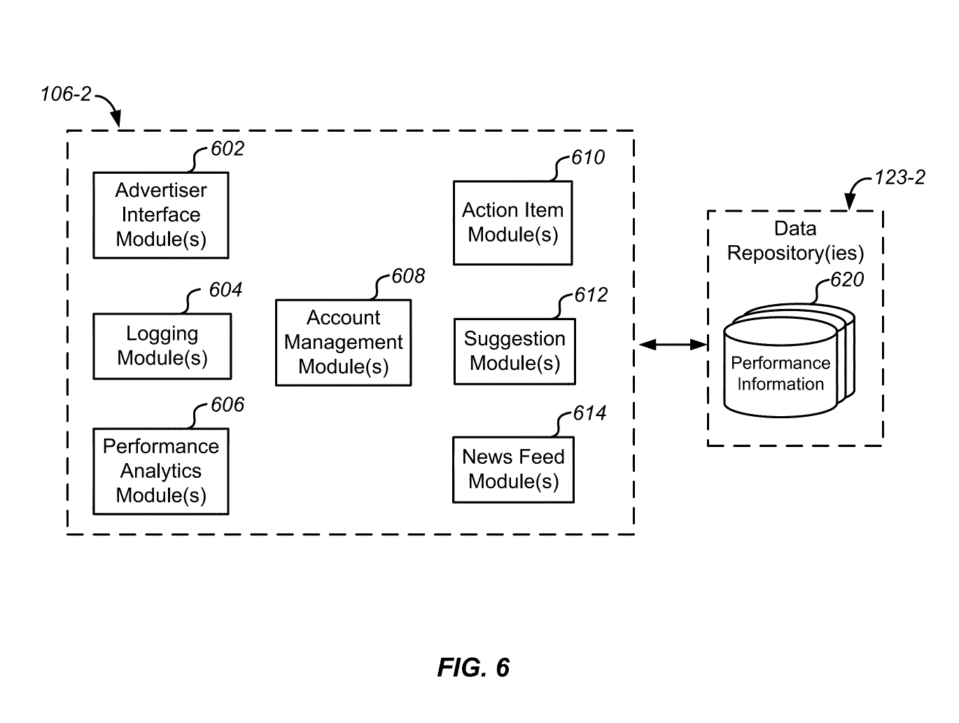

FIG. 6 depicts a functional block diagram of certain aspects of an advertising information handling system 106-2 that may be or include an advertising platform, in accordance with certain embodiments of the present disclosure. The advertising information handling system 106-2 may include one or more of an advertiser interface module 602, a logging module 604, a performance analytics module 606, an account management module 608, an action item module 610, a suggestion module 612, and/or a news feed module 614. While certain components are described separately herein, it should be appreciated that the components may be combined and/or implemented differently, with additional, less, or different components, in any combination to provide certain features in various embodiments.

The advertiser interface module 602 may correspond to the advertiser interface 110A. The advertiser interface module 602 may include logic to present and receive information to/from an advertiser 110. In various embodiments, by way of example without limitation, the advertiser interface module 602 may facilitate one or more of an API, a website, a web page, a web portal, a web application, a mobile application, enterprise software, and/or any suitable application software. In some embodiments, a mobile application 151, which is configured to run on a computing device 102, may be provided. The mobile application 151 may be provided in any suitable way. For non-limiting example, the mobile application 151 may be made available from the advertising information handling system 106 or any website for download to the advertiser computing devices; alternatively, it may be pre-installed on the advertiser mobile computing device.

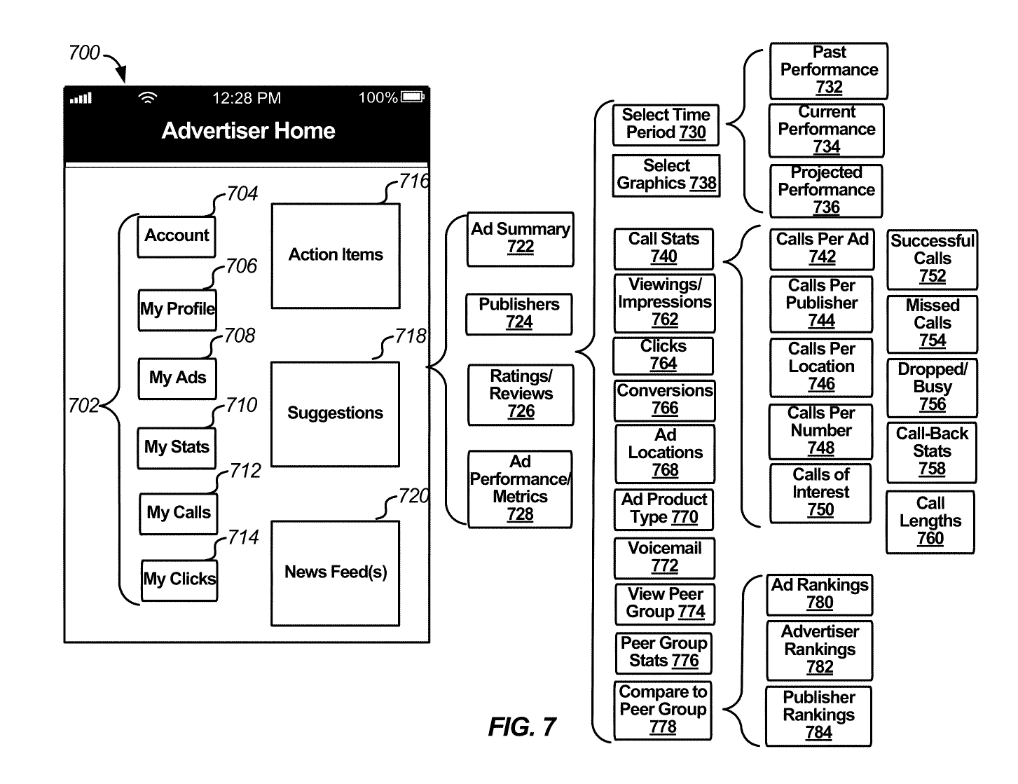

FIG. 7 illustrates one embodiment of an advertiser interface for an advertising platform, in accordance with certain embodiments of the present disclosure. In certain aspects, the advertiser interface for the advertising platform may include a dashboard 700. After an advertiser logs in, different data points that can be of use for the advertiser may be presented to the advertiser. The dashboard 700 may include any software process or module operable to present and receive information to/from an advertiser 110, allow an advertiser to monitor advertising and other published content information, select different types of advertising data, identify desired metrics, automatically generate dashboard views, customize dashboard views, configure advertising and published content for publication, select publication options, and/or the like. The example of the dashboard 700 is not limiting, but may be illustrative of a mobile application interface.

In some embodiments, the dashboard 700 may correspond to an advertiser home page that an advertiser might see upon initialization of the app or logging on to the platform. The dashboard 700 may provide a graphical user interface (GUI) that includes any number and type of user-selectable options 702 to facilitate various embodiments. In various embodiments, one or more user-selectable options 702 may include one or more of a screen-labeled function key, an icon, a button, a soft button, a window, a menu, a control widget, a scroll bar, a slider, a listbox, and/or the like. In various embodiments, one or more user-selectable options may be selectable via one or more of touch, push, movement-based selection, and/or any suitable navigation feature.

The advertiser home page may allow for a high-level presentation of features that allow for drilling down into more specific features. In various embodiments, to facilitate various aspects, the user-selectable options 702 may include one or more of an account feature 704, a profile management feature 706, an advertisements management feature 708, an advertisement statistics feature 708, a call management feature 712, a click management feature 714, an action item feature 716, a suggestions/recommendations feature 718, and/or a news feeds feature 720. In various embodiments, any one or combination of the features may include automatically presented information on the advertiser home page.

The account feature 704 could allow for a merchant to manage various account features such linking email accounts, linking telephone numbers, managing billing aspects, and/or the like. The profile management feature 706 may allow for a merchant to configure and manage one or more of the various profile features discussed herein, such as setting up and modifying notification preferences, selecting advertising/publication campaign packages, advertising, publication, and offer targeting, etc. The profile management feature 710 could also allow for the viewing of profile analysis information, where the advertiser's composite profile information may be composed and presented by the system, e.g., to give the advertiser a snapshot of the advertiser's composite attributes, which could be presented in comparison to other advertisers, as discussed herein.

The advertisements management feature 708 could include and/or segue to an advertisement summary feature 722. The advertisement summary feature 722 may be configured to present a list or otherwise present a compilation of an advertiser's advertisements and/or other published content with access to further details. The summary may present information such as listing creation date, listing identification information, listing publisher information, publication date, listing content, forms of content, listing status, listing expiration, and/or any other appropriate listing information. The listing publisher information could identify the publisher(s), published details, descriptions, errors, invitations to fix any problems, etc.

Updates of interest may be automatically presented to the advertiser. For example, in some embodiments, the updates may include one or more news feeds. In some embodiments, the updates may be real-time updates. For example, information corresponding to one or more of an action item 716, suggestion 718, and/or a news feed may be automatically presented on the advertiser home page. The action items 716 and/or suggestions 718 could correspond to potential/suggested advertisements, advertisement/content improvements, advertisement products, publishers, profile changes, and/or the like that may be presented. In some embodiments, such action items 716 and/or suggestions 718 may be identified/selected based on comparison with an advertiser's current advertiser profile with other profiles. The other profiles could include an ideal profile tailored to a specific vertical and/or service category or which may be at least partially based on other profiles of other advertisers. In some embodiments, the reference profile could be based on a composite of advertiser information for advertisers, thus allowing for analysis of a particular advertiser relative to others.

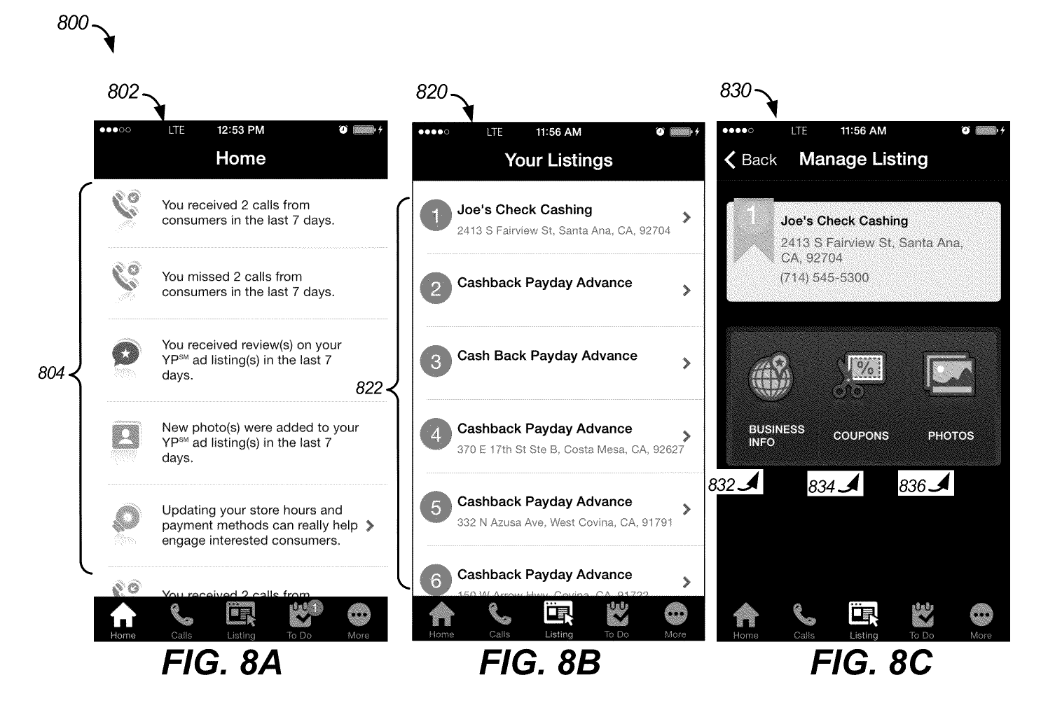

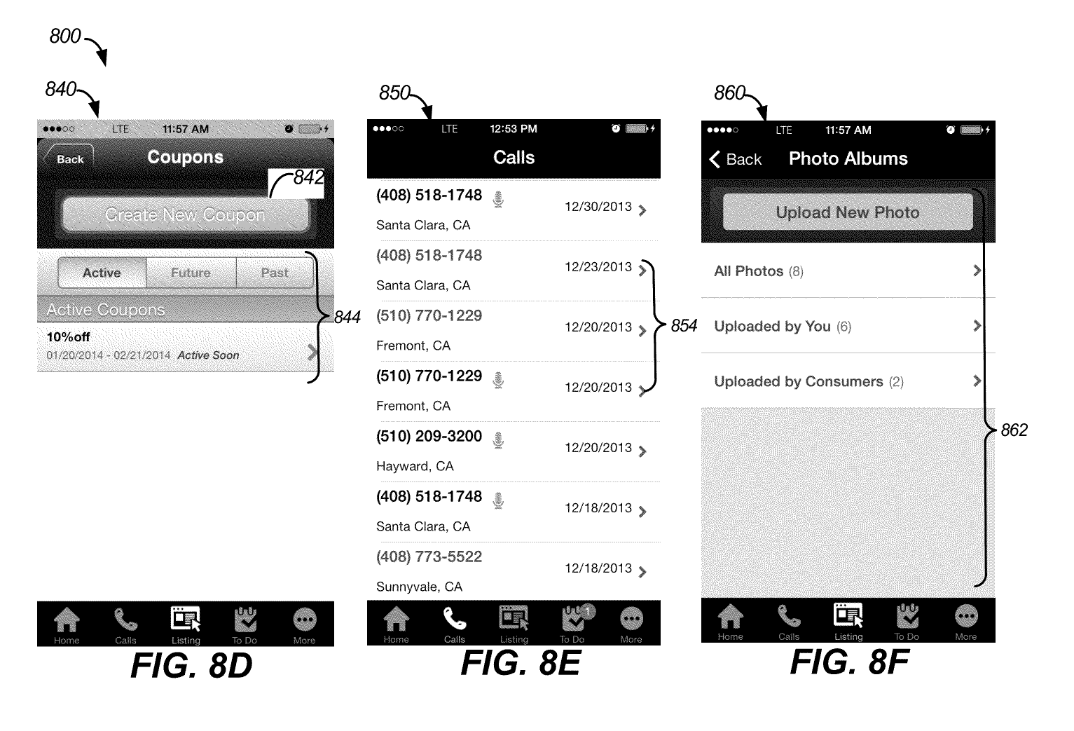

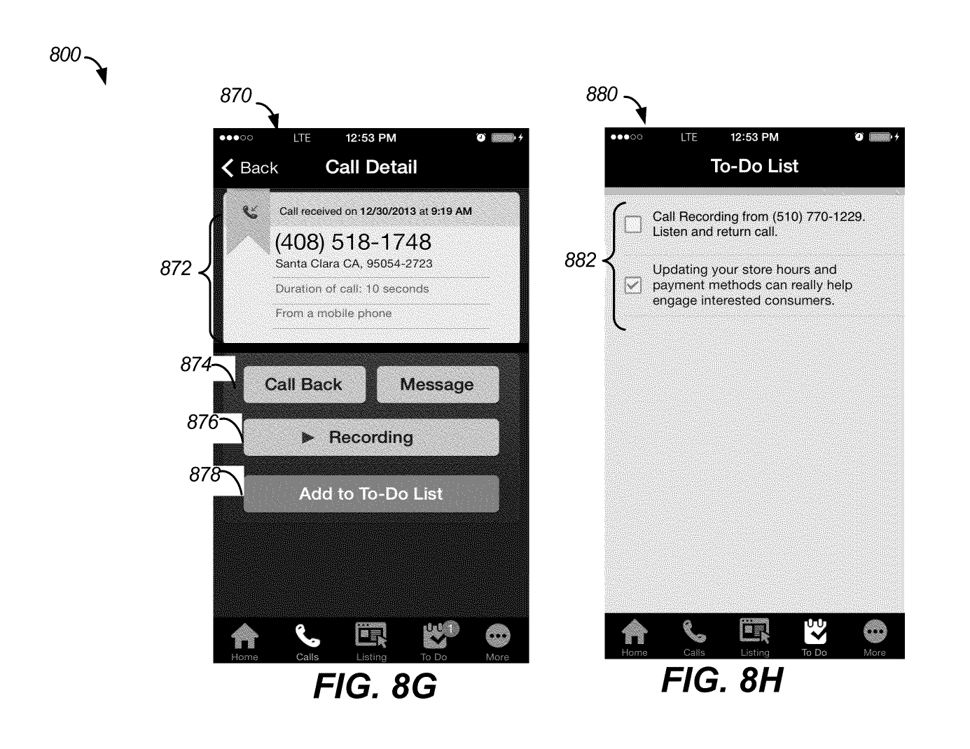

FIGS. 8A-8H are screenshots illustrating non-limiting advertiser interface examples, in accordance with certain embodiments of the present disclosure. The advertiser interfaces 800 may be displayed via a mobile application or any suitable interface in various embodiments. The advertiser interfaces 800 may be similar to other interfaces described herein, such as the advertiser dashboard 700, and may include any one or combination of features of other interfaces described herein.

In some embodiments, the advertiser interfaces 800 may provide an advertiser home view 802, as depicted in the example of FIG. 8A. The home view 802 may automatically present updates 804 of interest to the advertiser. For example, the updates 804 may include indications of calls received from consumers over a certain time period, calls missed from consumers over a certain time period, reviews received over a certain time period, new photos added over a certain time period, suggestions, and/or the like. The updates could be presented with user-selectable options to drill down to details and access additional user-selectable options regarding the updates. Accordingly, a business representative could receive regular updates on calls, clicks, reviews, and other consumer activity responsive to the published content of the business. The home view 802 resents just one possible example out of many in accordance with various embodiments.

The advertiser interfaces 800 may provide a listing summary 820, as depicted in the example of FIG. 8B. The listing summary 820 may be configured to present a list 822 or otherwise present a compilation of an advertiser's advertisements and/or other published content with access to further details. A high-level list 822 that identifies each content item may be presented initially with user-selectable options to drill down to details for each content item. Accessible information may include such information as listing creation date, listing identification information, listing publisher information, publication date, listing content, forms of content, listing status, listing expiration, and/or any other appropriate listing information. The listing summary 822 may allow a business representative to ensure the accuracy of listings for a business.

As one non-limiting example, FIG. 8C presents an individual listing management view 830. The individual listing management view 830 may include user-selectable options for uploading, entering, selecting, modifying, previewing, and/or otherwise configuring business information 832, coupons 834, photos/images 836, and/or other user-selectable options that allow a business representative to configure content to be published. The business information 832 could include including address information, directions, ratings information, map information, business details, hours, contact information, description and a list of representative products, for example.

One or more user-selectable options, which may involve workflows, may be provided via the listing manager to allow a merchant to create and/or designate certain offer information. The user-selectable coupon option 834 is presented as one non-limiting example. In the example, selection of the option 834 may allow a segue to an offer manager. As one non-limiting example, FIG. 8D presents a coupon management view 840. One or more user-selectable options for coupon creation 842 may be provided. In some embodiments, one or more user-selectable options may be provided for an offer summary 844 configured to present information for offers retained by the system for the merchant. The offer summary 844 may present options for active, future, and past offers of the merchant, and may include information such as offer creation date, offer identification information, specific form of provisioning, offer status, offer expiration, and/or any other appropriate offer information.

While the example of coupons could include one or more of an electronic coupon (which could correspond to a savable and/or printable discount coupon), various embodiments could allow for other types of offer/promotion content. A merchant could upload any suitable offer information in any suitable form in various embodiments. For example, a merchant could upload an electronic coupon, images and/or other graphical/video data, audio data, and/or the like. Such uploaded data could correspond to any suitable advertising content.

In some embodiments, one or more templates may be provided for selection and/or input of desired details for advertising/listing, offer, and/or other content to be published by one or more publishers. Various advertising/listing and/or offer templates could be provided and presented to allow a choice of one or more templates. The various template options could differ in terms of style, content, form, and/or the like. A template could include fields for entry of information by the merchant. For example, to configure an offer such as a coupon, the merchant may have an option to designate a service(s) and/or product(s), offer/discount information, start date, expiration date, terms and conditions, and/or any suitable information to facilitate offer information provisioning. In some embodiments, the publication manager may at least partially populate a template with merchant information based at least in part on listing information and/or offer information already retained for a specific merchant. For example, a template could be pre-populated with merchant information such as business name, business location, and/or the like. In cases where there are multiple options for a given advertiser (say, multiple locations, multiple goods/services, and/or the like), the listing and/or offer manager could identify those options and facilitate user-selectable options for the merchant to designate.

In some embodiments, a merchant may upload information for use in provisioning offer and/or other content for publication, and the publication manager could be configured to provide user-selectable options to facilitate such uploading. As one non-limiting example, FIG. 8E presents a view 850 of a photo management interface to facilitate uploading and management of a merchant's photos/images. One or more user-selectable options for uploading 852 may be provided. One or more user-selectable options for managing uploaded photos/images 854. The system may retain photos/images uploaded by the businesses representative, but also may retain photos/images uploaded by consumers in some embodiments. The photos/images uploaded by consumers could be gathered from the one or more publishers. Consumers could upload content associated with the particular business for any suitable reason. For example, a consumer could upload a photo of a problem to inform the merchant. Say the merchant is directed to bathroom remodeling and restoration, a consumer could upload a photo of a cracked sink to give the merchant an idea of the consumer needs. As another example, a consumer could upload “before” and/or “after” pictures, say of a kitchen remodel. Another example could be “fan photos” of consumers enjoying the products of the merchants; the merchant could use the photos for republication as customer testimonials. In some embodiments, along with the uploading interface presented to the consumers, an authorization form could be presented to the consumer to authorize republication of the photo as a testimonial so that the merchant may be authorized to use the content as testimonial material.

The publication manager may determine the parameters for content that is to be published by a particular publisher and may be translate the content selected by the merchant for publication, say an uploaded photo and/or entered business information, to conform to the particular parameters of the particular publisher. For example, on behalf of the merchant, the publication manager may automatically resize, reformat, readjust quality/resolution, crop, and/or otherwise prepare an uploaded photo/image in view of the particular publisher. The publication manager may automatically select a set of information items, which could be a subset, according to the constraints of a particular publisher (e.g., due to space limitations, only certain information, such as a certain number of products, business name and general location but not full address, etc., could be listed with a particular publisher). The publication manager could present the business representative with a preview of the translated content for approval prior to transmission to the publisher. Once content has been prepared for one particular publisher, one or more user-selectable options could be presented to the business representative to publish with another publisher, and, responsive to user selection, the publication manager could retranslate the content to tailor the content to the additional publisher.

In some embodiments, a merchant may be provided with options to designate certain business rules for offer information provisioning. Such business rules could specify one or more temporal conditions, such that provisioning may depend on one or both of temporal condition(s) and trigger events. Temporal conditions could include one or more of time parameters, day parameters, date parameters, location parameters, and/or the like that could be conditions for offer provisioning. Business rules specifying time parameters could include, e.g., rules for handling provisioning in view of a time of day when a trigger event occurs. Business rules specifying day parameters could include, e.g., rules for handling provisioning in view of a day of the week when a trigger event occurs. Business rules specifying date parameters, e.g., could include rules for handling provisioning in view of a date on which a trigger event occurs. Any suitable interface features, including input fields, telephone dialer inputs, IVR inputs, and/or user-selectable clock, calendar, and/or like GUI components could be provided to faciliate advertiser specification of business rules in various embodiments.

Business rules specifying location parameters could include, e.g., rules for handling provisioning in view of a location identified for an end user. Accordingly, with an advertiser profile, a merchant may be able to indicate specific areas for which particular offer provisioning to be targeted. In various embodiments, a target area could be specified in any suitable manner, including, for example, by one or more counties, municipalities, zip codes, distances from reference points, etc. In some embodiments, a user-selectable map interface may be presented as described herein.

Business rules specifying trigger event(s) could include, e.g., rules for handling provisioning in view of any one or combination of events associated with an advertiser's published content. For example, trigger events could include one or more of an end user adding a business to a favorites collection, a sharing of information about the business with other end users of a platform, a sharing of information about the business via a linked account (e.g., email, text message, online social/business networking services—one or more of which could be differentiated with distinct rules for handling sharing with distinct accounts), an end user assigning approval/disapproval indications (e.g., liking, thumbs-up, rating, etc.) to published content about the business, adding content (e.g., comments) to a published content about the business, uploading photos to the merchant, a time period elapsed since a last activity with respect to a businsess, an end user's search relevant to the business, a search for other merchants (e.g., a search which could potentially turn up competitors), and/or the like.

Business rules specifying a form of provisioning could include, e.g., rules for provisioning offer information via one or more of text messages, voice notifications, push notifications, e-mails, social/business networking services account postings/messages, alerts with the application, and/or other any suitable means. The offer manager may be configured to present an offer that a merchant has set up for previewing. In some embodiments, the system may subsequently use any one or combination of merchant-specific business rules to identify appropriate offer information options for one or more of a particular end user, trigger event, and/or conditions. In some embodiments, the system may be configured to automatically provide offer information to an end user based on the merchant-specific business rules on behalf of the particular merchant without further merchant intervention. In some embodiments, the system may be configured to present automatically identified offer information (i.e., identified based on the merchant-specific business rules) for merchant selection so that the merchant may have the choice as to whether to dispatch the offer information.

In some embodiments, the system can select pertinent offer information for transmission, select a delivery manner/form, and/or transmit pertinent offer information responsive to a trigger event based at least in part on the advertiser profile. In some embodiments, the system may be configured to provide one or more offer information options to a merchant based on the merchant-specific business rules. Accordingly, the system can filter various offer information provisioning options with the merchant-specific business rules and present an appropriate subset of those options to a merchant for merchant selection.

In some embodiments, the offer manager may be configured to present offer suggestions. The offer suggestions could prompt the merchant to create offers that the merchant has not already created. For example, offer manager may identify potential trigger events related to the merchant, and may query the merchant to whether create an offer in view of the potential trigger events. Accordingly, certain embodiments may provide a merchant with a way to communicate with end users that are not only potential customers, but also potential promoters of the merchant. Certain embodiments may allow a merchant to market events, product offerings, and/or service offerings to end users.

The advertiser interfaces 800 may provide a call summary 860, as depicted in the example of FIG. 8F. The call summary 860 may be configured to present a list 862 or otherwise present a compilation of an advertiser's call with access to further details. A high-level list 862 that identifies each call may be presented initially with user-selectable options to drill down to details for each call. The listing summary 862 may allow a business representative to actively manage calls, with call details and recordings.

As one non-limiting example, FIG. 8G presents an individual call management view 870. The individual call management view 870 may include call details, such originating telephone number, time(s)/date(s) of call(s) received, locality associated with the caller, call duration(s), type of caller phone (e.g., mobile phone or landline), caller history, etc. User-selectable options for responding to the call 874 (e.g., by calling back, messaging the call, sending the caller an offer such as a coupon for example via text message, etc.), listening to a recording 876, adding to call to a to-do list 878, and/or the like may be provided.

FIG. 8H presents a to-do list view 870, where tasks 882 added by the business representative may be maintained. In some embodiments, the tasks 882 could include action items and suggestions automatically determined by the system and added to the list. The action items and suggestions could correspond to those disclosed herein.

Referring again to FIG. 7, a publishers summary feature 724 may be configured to present access to details regarding publishers. The publishers could correspond to those publishers that have presented advertisements and/or any other content of a particular advertiser. The publishers could also correspond to potential/suggested publishers. The potential/suggested publishers may be identified/selected based on comparison with an advertiser's current advertiser profile with other profiles, which may include an ideal profile tailored to a specific vertical and/or service category or which may be at least partially based on other profiles of other advertisers.

Different data points regarding any of the aspects described herein (e.g., viewings, impressions, clicks, selections, approval/disapproval indicators, calls, texts, reviews, etc.) that can be of use to the business representative may be presented on a publisher basis. The publisher-specific information could be presented for any suitable time period, which time period could be user-selectable, and could be differentiated based on specific publisher used. For example, users reached via vertical-specific publishers or publisher categories (e.g., publishers directed to automotives) could be distinguished from users reached via social media publishers. The publisher information could reflect users who have visited a particular merchant website, contacted a particular merchant, and/or otherwise linked to a particular merchant via a publisher. The publisher information could be qualified according to any suitable bases, e.g., demographic information, visit number, value of customer, potential value of customer, quality of leads, social network connections, customer score, etc. And, such qualification could be graphically presented/distinguished in any suitable manner.

A ratings/reviews feature 726 may be configured to present access to details regarding ratings and/or reviews associated with an advertiser's advertisements, products, services, businesses, publishers, etc. The ratings and/or reviews may correspond to consumer feedback per surveys and/or any suitable feedback gathering tool. Approval/disapproval indicators may be harvesters from one or more publishers, which indicators may be in form of likes, dislikes, thumbs-up, thumbs-down, star-scale ratings, number-scale ratings, fan indications, affinity group association, messages to businesses, and/or the like. In some embodiments, consumer reviews can fed back to the system and processed according to a keyword analysis in order to identify and gauge approval/disapproval. In some embodiments, ratings and/or reviews may correspond to industry assessments, peer assessments, and/or assessments provided by the advertising platform that could be based on comparison with an advertiser's current advertiser profile with other profiles, which may include an ideal profile tailored to a specific vertical and/or service category or which may be at least partially based on other profiles of other advertisers.

The advertisement statistics feature 708 could include and/or segue to an advertisement performance metrics feature 728 may be configured to present access to details regarding any suitable advertisement performance metrics, such as any one or combination of the various advertisement performance metrics described herein. The metrics may include information about the number of users reached by a particular merchant, by merchants corresponding to a particular category (e.g., a service category, a product category, any suitable business category, etc.), by merchants corresponding to a particular locale, and/or the like.

Such metrics could be graphically differentiated along any suitable lines. Any suitable geographic segmentation may be employed in various embodiments, including neighborhood, city, metro area, county, and/or the like. In some embodiments, one or more user-selectable options may be provided for user-specified geos of interest to analyze data corresponding to the user-specified geos. For example, a user may be able to indicate a range, such as a radius of X miles from specified location of interest. In some embodiments, a user could indicate an area of interest with any suitable parameters, e.g., including one or more counties, municipalities, zip codes, distances from reference points, etc. In some embodiments, a user-selectable map interface may be presented. Some embodiments may enable a merchant user to define an area by selecting one or more points on the map interface. For example, any predefined service areas, such as zip codes and/or the like, could be presented on the map for selection. The map interface could allow a user to define a perimeter of a service, e.g., by drawing on the map with a line drawing tool, cursor, finger/stylus contact with a touch interface, selection of perimeter boundaries such as roads, rivers, etc. Hence, share indicia may be location-specific and windowed in any suitable degree of granularity to provide enhanced relevance.

A time period selection feature 730 may be configured to allow for selection of a time period for which to view certain performance metrics. Past performance, current performance, and projected options 732, 734, 736 may be provided. Past performance could show performance metrics for past week, month, billing period, three months, six months, year, etc. Current performance could show real-time performance in the context of recent activity such as the last hour, day, week, etc. Additionally, current data could be compared to past data and such comparative data may be presented with differential indicia, such as percentage increases/decreases. Projected performance could show extrapolation of past and/or current performance data into future, such as any coming time period. Projected performance could be based on any suitable factor, including aggregate performance of other advertisers in the market, publisher performance, market data for a particular location, and/or the like.

A graphic selection feature 738 may be configured to present access to details of advertisement performance metrics and/or any suitable data according various embodiments herein in any suitable format with any suitable graphics. By way of example without limitation, pie charts, bar graphs, line graphs, tables, with features allowing ordering and/or filtering of data according to any suitable criteria, matrices, Venn diagrams, images, photos, and/or the like may be implemented according to various embodiments. In some embodiments, the graphic selection feature 738 may allow for advertiser customization and/or manipulations of graphics presented with the dashboard 700.

As part of the advertisement performance metrics, a call statistics feature 740 may be configured to present access to details regarding any call in response to the advertiser's advertisements. Options for presenting access to details about call per particular advertisements/published content 742, calls per particular publishers 744, calls per particular location 746, calls using a particular number 748, calls of interest 750 which may be based on any suitable additional information, such as intelligence about a particular caller of interest, a particular location of interest, etc., successful calls 752 that were successfully connected, missed calls 754, dropped calls/calls receiving a busy tone 756, call-back statistics 758, call lengths 760, and/or the like. For instance, the call of interest feature 750 could identify a number of calls from a particular call in a particular time period as an indication of interest. A caller who has made five calls to a particular advertiser or to advertisers in a particular service category in the last ten minutes may be taken as an indication of high interest. As another example, the call-back statistics features 758 could indicate an advertiser's average time to call a consumer back. When a consumer clicks on an advertisement, information may be known such that time may be tracked between the advertising information handling system 106 sending an alert to the corresponding advertiser and the subsequent opening of the application on the advertiser's end. The advertisement performance metrics feature 728 may be configured to present access to details regarding any advertisement viewings/impressions 762, advertisement clicks 764, advertisement conversions 766, advertisement locations 768, advertisement product types 770, voicemail left by callers 772, and/or the like.

A peer group feature 774 may be configured to present access to details regarding peer group of advertisers. A peer group of advertisers could be identified and/or defined by advertising category and/or geography. A peer group statistics feature 776 may be configured to present access to details any suitable performance data regarding a peer group.

The data could be anonymized in some embodiment to only show aggregated information; in other embodiments the data may not be anonymized, but may tie particular data to particular advertisers in the peer group. For example, the data could be specifically tie to particular advertisers of a sales force within a company. A peer group comparison feature 778 may be configured to present access to details regarding comparisons of a particular advertiser's performance to performance of a peer group of advertisers. Any type of performance data may be compared. By way of example without limitation, the peer group comparison feature 778 may allow for advertisement rankings 780, advertiser rankings 782, and/or publisher ranking 784 with respect to the peer group. For instance, average and top performers could be identified, a top ten performer could be identified, etc. A comparison to a peer group may indicate, for example, that plumbers on average are getting ten calls/day, and that a particular advertiser is only getting five calls per day. As another example, a comparison to a peer group may indicate advertisement products and/or packages that advertisers in the peer group have, generally or specifically. For instance, a comparison may reveal that most plumbers have a bronze package that generates an average of ten calls per week, but those that have a silver package generate an average of 20 calls per week.

It is to be understood that the depicted dashboard 700 is for example purposes only. Accordingly, the dashboard 700 may provide a GUI that may include or present data for an advertiser interface of an advertising platform in any suitable format with any suitable layout of any suitable sets/subsets of features, along with any desired graphical depiction of information, to facilitate features of various embodiments of the present disclosure.

Referring again to FIG. 6, the advertising information handling system 106 may include one or more logging modules 604. The logging module(s) 604 may be configured to perform logging processes to receive and log data of interest for advertisements and/or listings. The performance analytics module(s) 606 may include logic to retrieve, process, derive, compile, aggregate, handle, store, report, and/or present information relating to performance data associated with advertiser accounts. The performance analytics module 606 may be configured to present any desirable information in any desirable manner. With respect to a particular advertiser, the logging module 604 and performance analytics module 606 may facilitate various features of an advertiser interface for an advertising platform, in accordance with certain embodiments herein. For example, the logging module 604 and performance analytics module 606 may facilitate one or more of the advertisements management feature 706, the advertisement statistics feature 708, the call management feature 712, the click management feature 714, etc.

As used herein, “advertisement” and/or “advertising information” may encompass “listing,” “listing information,” and/or any published content on behalf of a business in certain embodiments. The advertisements could be those sent to publishers and/or end users. The data may be performance data that is indicative of advertisement performance, may be data indicative of performance data, and/or may be data from which performance data is derivable. In various embodiments, data that can be used to track performance of an advertisement may be received directly by the advertising information handling system 106 or via a publisher. In some embodiments, advertisements sent to publishers may be tagged in any suitable manner that allows tracking of any desirable aspects of advertisement performance.

In some embodiments, performance data and/or data that can be used to derive performance data may be stored in a performance data repository 620. The data may be consolidated in any suitable manner. For example, the data could be consolidated on an advertiser basis, a publisher basis, a service category basis, an advertising product/pricing model basis, and/or the like.

Data of interest could indicate a manner in which a user interacted with an advertisement. Data of interest could include call data. For example, data could be indicative of calls responsive to advertisements and/or listings. Data could be indicative of call-backs from a publisher's server. Data could be indicative of a number of calls that are responsive to a particular advertisement from end users in a certain time period. For pay-per-call ads, calls may be logged in to a call center, such as one implemented with the call handling module 125. Using tracking numbers, the phone number that was dialed by a user could be mapped to advertisers, advertisements, and/or publishers. In various embodiments, phone numbers and/or extensions, which may or may not include aliases, may be assigned to advertisers as unique to advertisements, as shared by certain advertisements, as unique to an advertiser, as shared by certain advertisers, as unique to a publisher, as shared by certain publisher, and/or on any suitable basis. For example, in some embodiments, a publisher may be assigned a single number for a set of advertisers. In some embodiments, an extension may be assigned to the publisher for each of the advertisers. In some embodiments, an advertiser may receive a single/base telephone number for a set of publishers. In some embodiments, an extension may be assigned to the advertiser for each of the publishers.

The logging module 604 may include tracking logic to track calls, in accordance with certain embodiments. In some embodiments, the logging module 126 may be configured to identify whether a caller is successfully connected with an advertiser, whether the call is missed, whether the call is dropped/disconnected/receives a busy tone, whether the call is routed to voicemail, and/or whether a voicemail is left. In some embodiments, the logging module 126 may include ANI logic to identify numbers of callers. In some embodiments, the logging module 126 may be configured to track the length of calls. In some embodiments, the logging module 126 may be configured to record calls.

Data of interest could include click data. For example, data could be indicative of clicks to advertisements. For example, data could be indicative of a number of clicks, whether by logging the direct request of the clicks or a concomitant tracker, that a particular advertisement received from end users via computing device in a certain time period.

Data of interest could include other types of data. For example, data could include one or more of advertisement viewings/impressions; advertisement conversions; third party data; publisher data, which publishers have presented which advertisements and associated details, such as numbers of showing on publisher sites over a certain time period, how many views per time period, which could be on a per publisher site basis; review data, such as reviews associated with an advertisement, ratings, how many times a review is read; feedback data that may indicate user preferences, such as user preferences regarding certain advertisements; more details around call/click data, caller name information from calling name delivery (CNAM), also known as caller identification or caller ID; location information, such as information about the area of a caller, demographic data about the area, history for a particular area; history for particular callers, and/or the like.

In some embodiments, the performance analytics module 606 may be configured to present comparative data. For example, current performance data may be compared to past performance data. A particular advertiser may compare that particular advertiser's performance to performance of a peer group of advertisers. A peer group of advertisers could be identified and/or defined by advertising category and/or geography. Any type of performance data may be compared. An advertiser may have user selectable options to select different types of statistics for comparison and order by different types of statistics.

Statistics could be based on time, that is, what has happened in the last hour, day, week, etc. Statistics could be filtered based on distance. For example, statistics could indicate that one or more calls and/or click originated from a distance of X miles with respect to a reference point.

In some embodiments, the advertising information handling system 106 may include one or more account management modules 608. The account management module 608 may be configured to allow an advertiser to management the advertiser's account. Management options may be provided for the advertiser to one or more of make changes to the account, contact customer service, change/update the advertiser's profile, change/update the advertiser's preferences, create/change/update the advertiser's advertisements, select various advertising products, management call-back settings, manage alert settings, and/or the like.

The advertiser account management module 606 may include logic to retrieve, process, derive, compile, aggregate, handle, store, report, and/or present information about items of interest associated with advertiser accounts. For example, items of interest could include important activities associated with an advertiser account. Items of interest could include whether an advertiser is missing calls from consumers and other information associated with the missed calls, such as details surrounding the missed (e.g., number of calls, times of calls, numbers called, listings/advertisements/publishers prompting missed calls, caller information, location information, and/or the like). Items of interest could include any actions happening on their account, such as someone is reviewing the account, comments/postings are being made on/about the account, a photo has been uploaded to the account, a review is added to the account, and/or the like. Items of interest could include any billing information associated with the account. Items of interest could include any messages associated with the account, such as messages from customer service, from publishers, from end user, and/or the like. Items of interest could include any calls associated with the account, such as calls from customer service, from publishers, from end user, and/or the like.

In some embodiments, the advertising information handling system 106 may include one or more action items modules 610. The action items module 610 may include the logic to alert the advertising items requiring action on the advertiser's part. For example, action items may include one or more of billing items, such as a bill coming due or past due and options to pay bills. Action items may include a notification of a website, mobile app, product, etc. ready for an advertiser's approval to have the advertiser's advertisement included in the website, mobile app, product, etc. Options for approval may be provided. For example, a click-here-to-approve soft button may be provided. Options may include providing a preview of website, mobile app, product, etc., such as presenting a web page to show how the website looks.

In some embodiments, the advertising information handling system 106 may include one or more suggestion modules 612. The suggestion module 612 may be configured to allow suggestions and recommendations to be presented to the advertiser. For example, one possible suggestion may be a notification that the advertiser's business profile is not complete, but, that if completed, the advertiser's traffic likely will increase. Another possible suggestion may include a notification about the latest coupon that could be added to an advertisement of the advertiser. Another possible suggestion may include a notification about a new advertising product available and appropriate for the advertiser.

In some embodiments, the advertising information handling system 106 may include one or more news feed modules 614. The news feed module 614 may be configured to allow industry vertical/marketing specific messages. For example, an advertiser may be presented with various types of news feeds to select and sign up for such that the news feeds may be presented to the advertiser via the advertising platform.

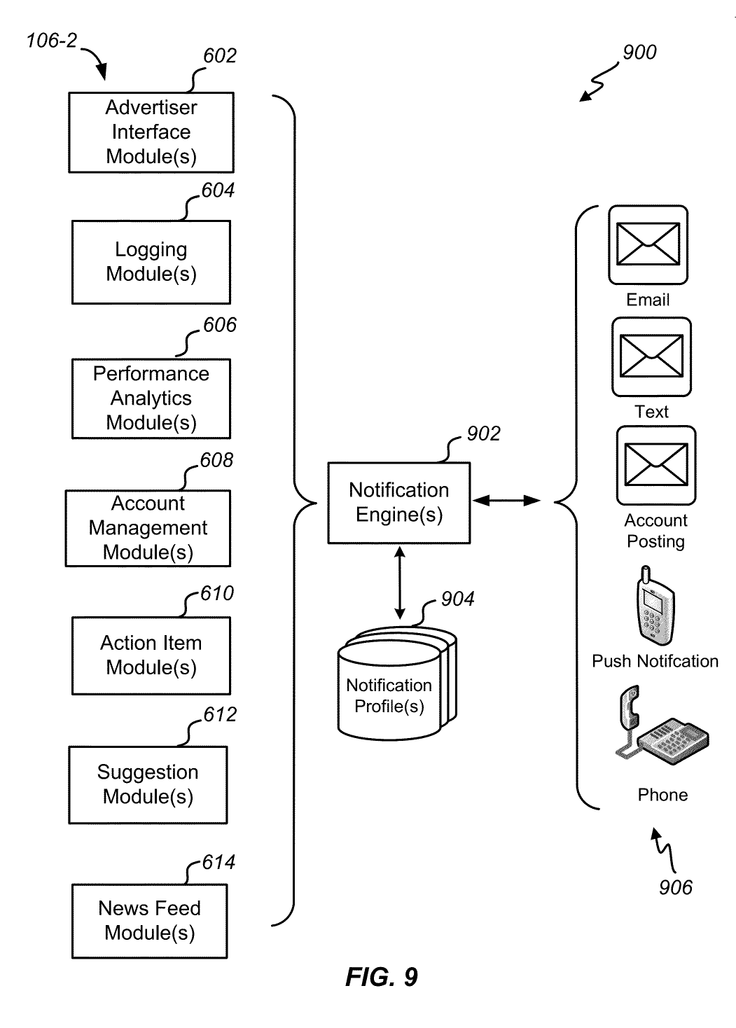

FIG. 9 illustrates a simplified functional block diagram of a notification subsystem for an advertiser alert system 900, in accordance with certain embodiments of the present disclosure. One or more of the advertising interface module 602, logging module 604, performance analytics module 606, account management module 608, action item module 610, suggestion module 612, news feed module 614, and/or other module(s) of advertising information handling system 106 may identify an item of potential interest. A notification engine 902 may be configured to determine whether an advertiser should be notified regarding an item of potential interest. In some embodiments, the notification engine 902 may make such a determination based at least in part on a notification profile. The notification profile could be default profile or a profile tailored to a specific advertiser or advertiser category. An advertiser 110 could opt for different types and frequencies of notifications according to various notification profiles. An advertiser 110 could identify which types of items of potential interest should trigger notifications and which should not. The notification profiles could be stored in one or more repositories 123, such as one or more notification profile repositories 904. The one or more notification profile repositories 904 may correspond to one or more repositories of various embodiments discloses herein and/or similar repositories.

With determinations about whether a given advertiser is to be alerted, certain embodiments may employ a variety of communication means 906 to notify the advertiser 110 in order to prompt the advertiser to certain positive results. Certain embodiments could include one or more of electronic notifications, telephonic notifications, texting notifications, push notifications, etc. to the advertiser, and/or alert notifications posted to the advertiser's account with the advertising platform. Thus, for example, a mobile app, SMS text, or a web page may be used to alert an advertiser 110 regarding events of interest. An advertiser 110 may prefer various contingencies for notifications. For example, the notification profile 904 may allow the advertiser 110 to be notified once, every day, via one communication means 906 for certain items, and to be notified immediately for other items via another communication means 906. For example, an advertiser may to receive a newsfeed via an account posting the advertisement may see after opening a mobile app, but a push alert for missed a call, a bill coming due, and/or an advertisement of the advertiser that just showed up on a network.

The notification profile may provide that an advertiser not be disturbed at certain times and/or when a location of the advertiser is detected to be in a certain area, such as within one mile of the advertiser's home address. The notification profile may provide that an advertiser be contacted via one or more certain communication means 906 during certain time periods, and via one or more other communication means 906 during other certain time periods. The notification profile may provide that an advertiser be contacted via different telephone numbers, depending on the time period. The notification profile may provide that voicemails and/or recorded calls be transcribed and sent to the advertiser. Such transcription and sending to the advertiser may be contingent on a certain set of keywords being detected in the voicemails and/or recorded calls.

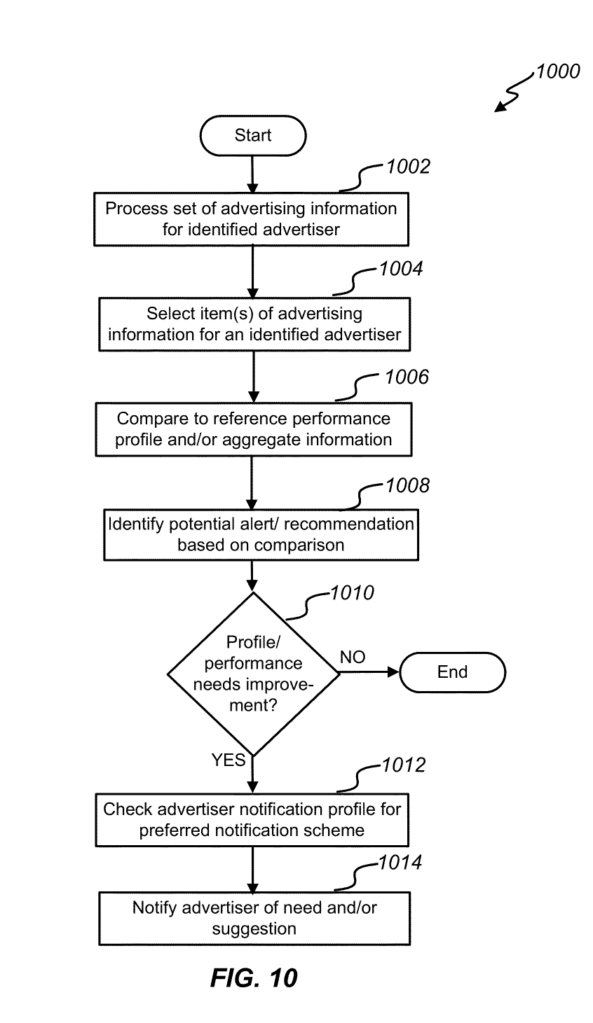

FIG. 10 illustrates a method 1000 for identifying notifications relating to an advertisers account, in accordance with certain embodiments of the present disclosure.

According to one embodiment, the method 1000 may begin at step 1002. At step 1002, a set of advertising information for an identified advertiser may be processed. For non-limiting example, the advertising information handling system 106 may access such information, which may correspond to the advertiser's profile, which may have been stored in a repository. As another non-limiting example, advertising information may be acquired, actively gathered, and/or pulled from one or more data sources, advertisers, end users, publishers (e.g., via APIs and API calls), and/or from the advertising information handling system's own handling of advertising information.

As indicated by step 1004, one or more items of the set of advertising information for an identified advertiser may be selected. As indicated by step 1006, the one or more items may be compared to a reference. The reference may be a performance profile. The performance profile may be a standard or other pre-identified profile for an advertiser in the identified advertiser's service category, location, or other circumstances. The reference may be aggregated information for the identified advertiser's peer group.

As indicated by step 1008, one or more potential alerts and/or recommendations may be identified based at least in part on the comparison of the one or more items to the reference. For example, one or more performance metrics of the identified advertiser may be compared to the reference, and a differential in the metrics may be identified for a potential alert and/or recommendation. As another example, missing information in the identified advertiser's profile may be identified for a potential alert and/or recommendation.

As indicated by step 1010, it may be determined whether the identified advertiser's profile and/or performance is need of improvement. The determination may be based on a comparison of the potential alerts and/or recommendations to one or more pre-determined thresholds. For instance, if a differential in the metrics is identified for a potential alert and/or recommendation and has met and/or exceeded a pre-determined threshold, it may be determined that improvement is needed. As another instance, if missing information corresponds to a threshold condition, it may be determined that improvement is needed. If the determination is in the negative, the process may end. However, improvement has been determined as needed, the process flow may transition to step 1012.

As indicated by step 1012, an advertiser notification profile may be checked for the identified advertiser's preferred notification scheme, which may indicate one or more preferred methods of contact. As indicated by step 1014, the identified advertiser may be notified of the need and/or suggestion according to the advertiser's notification profile.

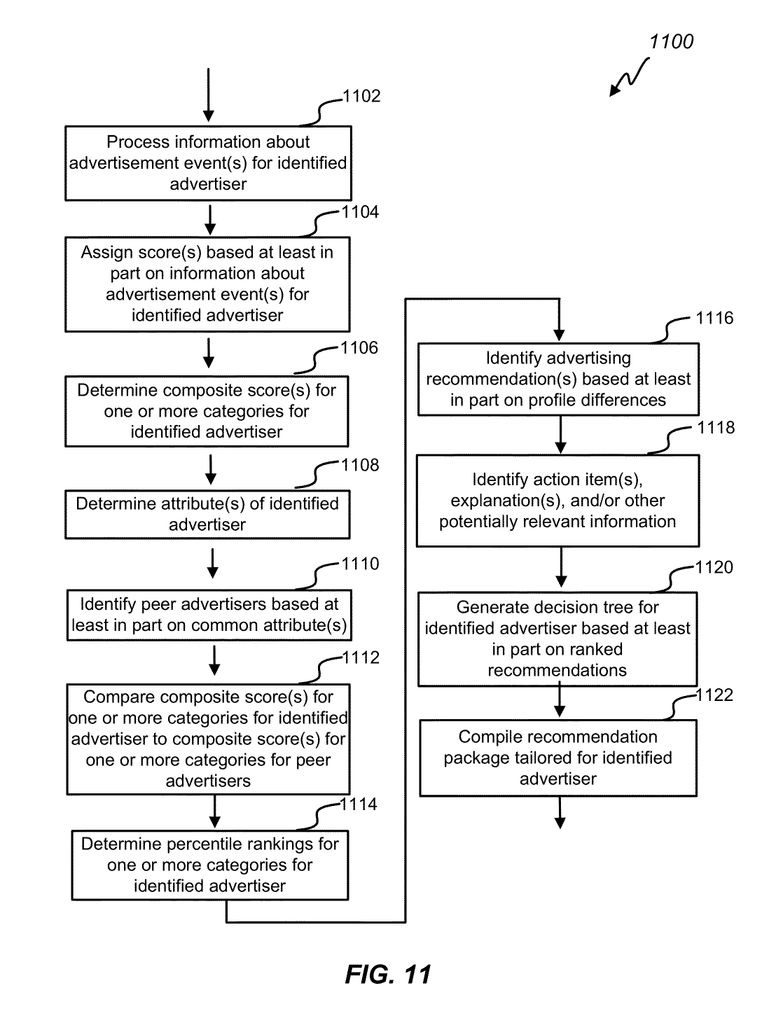

FIG. 11 illustrates a method 1100 for identifying recommendations for an advertiser, in accordance with certain embodiments of the present disclosure. According to one embodiment, the method 1100 may begin at step 1102. At step 1102, information about one or more advertisement events for an identified advertiser may be processed. The advertisement events may correspond to any one or combination of instances discussed herein of consumer activity responsive to published content relating to the identified advertiser.

As indicated by block 1104, one or more scores may be assigned based at least in part on information about the advertisement events for the identified advertiser. Any suitable numeric scoring scheme may be employed to quantify/qualify the instances of consumer activity. For example, each instance or set of instances may be assigned a certain score. Certain types of consumer activity could be weighted differently. For example, a consumer call may be weighted more heavily than a consumer click of an advertisement, and a consumer click of an advertisement may be weighted more heavily than a viewing. Any suitable weighting scheme may be employed in various embodiments.

As indicated by block 1106, one or more composite scores for one or more categories may be determined for the identified advertiser. A composite score could be determined for a category of consumer activity, such as a consumer calls, for example. A composite score could be determined for a category of advertisement product, such as a type of advertisement (e.g., directory listing, content to be published by a third party publisher, etc.). A composite score could be determined for a category of publisher/platform.

As indicated by block 1108, one or more attributes of the identified advertiser may be determined. The attributes could include, by way of example, service area, type of services offered, type of products offered, business size, number of business sites, relevant subject matter area, credentials, general cost, etc. As indicated by block 1110, one or more peer advertisers may be identified based at least in part on one or more attributes shared by peer advertiser and identified advertiser in common. For example, a peer advertiser could be offering the same type of service (say, plumbing, for example) in the same locality or a similar locality. As another example, a peer advertiser could be in the restaurant industry in the same or similar locality, offering the same or similar cuisine at generally the same the cost (say, a high-end steakhouse, for example).

As indicated by block 1112, composite score(s) for one or more categories for the identified advertiser may be compared to composite score(s) for one or more corresponding categories for the peer advertiser(s). In some embodiments, overall scores for the identified advertiser and the peer advertiser(s) may be compared. Score differentials may be determined. As indicated by block 1114, in some embodiments, percentile rankings for the identified advertiser may be determined. The percentile rankings could be relative to a set of peer advertisers. The set of peer advertisers could correspond to advertisers in the same general locality as the identified area. The set of peer advertisers could correspond to advertisers over any suitable region, for example, with respect to the country, a region of the country (say, the West Coast), a state, a metro area, regions having certain characteristics (say, metro areas have a certain threshold population), etc. Accordingly, the composite scores may be used to determine a performance profile for the identified advertiser so that the performance of the identified advertiser may be gauged with respect to performance profiles for multiple advertisers.

As indicated by block 1116, one or more advertising recommendations may be identified based at least in part on profile differences. In view of the comparison of overall scores, the overall performance of the identified advertiser may be gauged to determine whether there exists an overall deficiency. For example, an overall score that is below the average, mean, or other measure of peer advertiser overall score may be identified as indication of a need for improvement. An overall score less than any measure of peer advertiser overall score (say, the top X percent) may be identified as an opportunity for improvement. Beyond identifying overall score indicia, the system could drill down into differentials of scores for one or more categories to identify more specific differences. For example, say the differential for the identified advertiser's score for consumer clicks of ads with respect to peers meets or exceeds a certain threshold; that category may be flagged for further scrutiny to determine advertising strategy differences between the identified advertiser and the peers (e.g., what advertising products, publishers, form of media, advertising package, etc. are the peers using that the identified advertiser is not using).

As indicated by block 1118, one or more action items, explanations, and/or other potentially relevant information may be identified. Having identified more specific differences between the identified advertiser's strategy and the peers, specific action items to address the differences may be identified. For example, say that, based on the category scoring, the identified advertiser's click activity is X percent below peers who publish content via a certain set of one or more publishers and/or with a certain minimum number of publishers; action item(s) of a modifying the identified strategy to target the certain set of one or more publishers and/or the certain minimum number of publishers could be identified. Explanations and/or other potentially relevant information pertinent to the scoring, the categories, the strategic differences, the action items, and/or the like could be selected by the system and modified with specific analysis particulars to accompany the action items in order to provide context and insight to the identified advertiser for consideration of the action items.

As indicated by block 1120, in some embodiments, a decision tree for the identified advertiser may be generated based at least in part on ranked recommendations. In certain cases, there may be a multiplicity of potential action items that an identified advertiser may take based on the performance analysis. The potential action items could be ranked based on the positive impact that each action item would likely have on the performance of the identified advertiser. For example, say the identified advertiser has the largest differential category score in clicks per advertiser as compared to peers, and the advertising strategies are largely the same except for publishing content with certain publishers; publishing content with those publishers could be ranked highly. Additionally or alternatively, the potential action items could be ranked based on cost/ease of the action items. For example, adding photos to publish content could be identified as a relatively low-cost action item that would help the identified advertiser cure an advertising deficiency that exists with respect to the majority of the advertiser's peers. The easiest/low-cost action items could be identified in the decision tree before the more involved and higher-cost action items. The decision tree could rank actions and sub-actions. For example, the decision tree could lay out the decision of whether to publish content with additional publishers, and, as part of the that line of action, the decision could potential publishers according to any suitable basis, such as popularity with peers, productivity in providing consumer activity for peers, cost, advertising packages offered, etc.

As indicated by block 1122, a recommendation package tailored for the identified advertiser may be compiled. The recommendation package may include any of the performance metrics and analysis, advertising recommendations, action items, explanations, and/or other potentially relevant information, decision tree, advertising package offerings, and/or the suitable. The recommendation package could be presented to the identified advertiser via the advertiser interface and/or notification features disclosed herein.

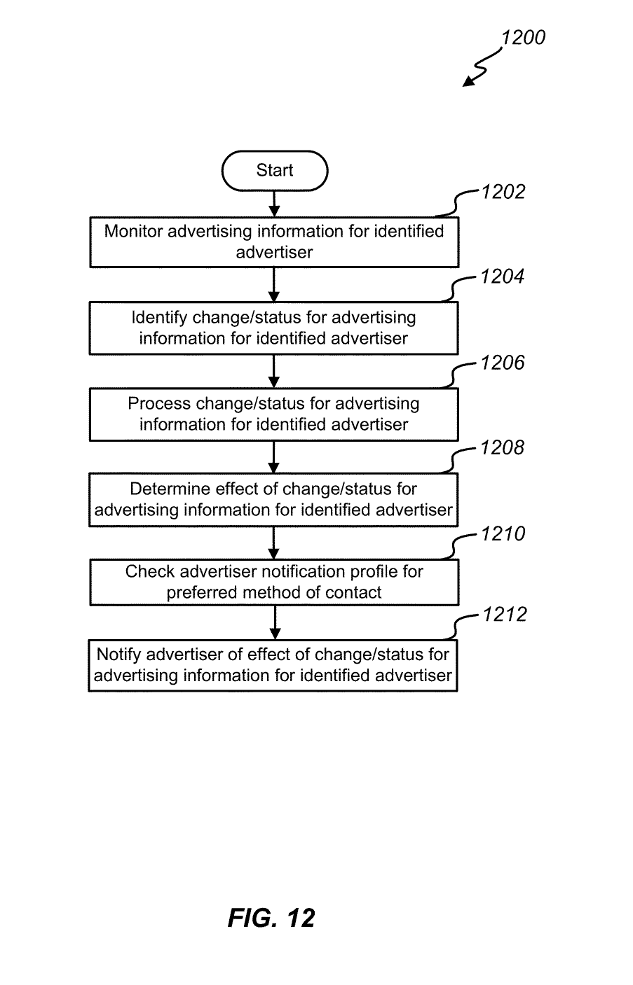

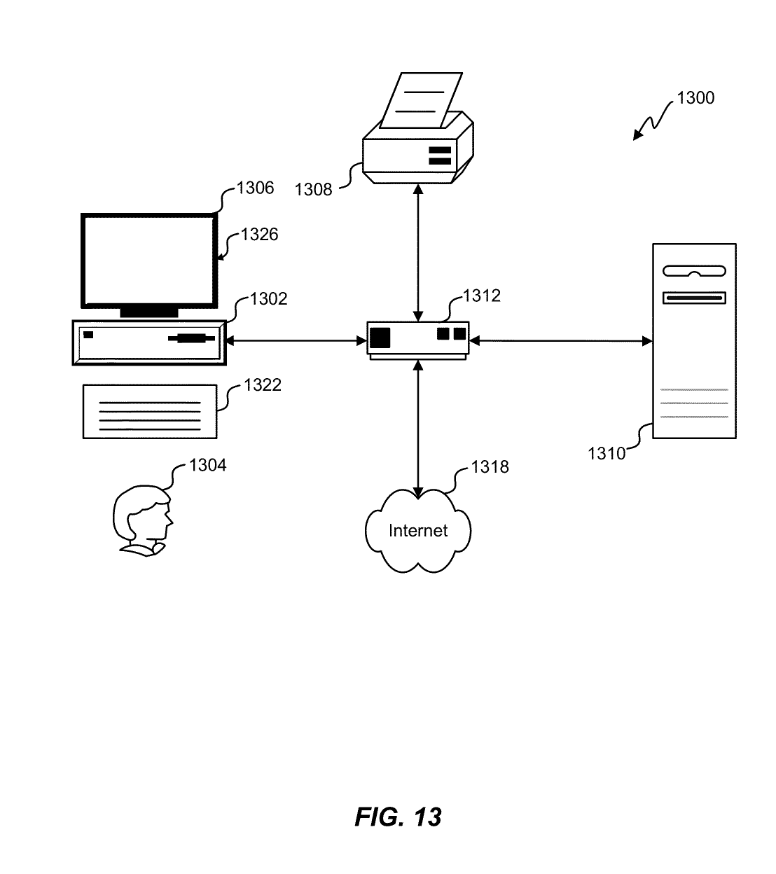

FIG. 12 illustrates an example method 1200, in accordance with certain embodiments of the present disclosure. Teachings of the present disclosure may be implemented in a variety of configurations that may correspond to the systems disclosed herein. As such, certain steps of the method 1200, and the other methods disclosed herein, may be omitted, and the order of the steps may be shuffled in any suitable manner and may depend on the implementation chosen. Moreover, while the following steps of the method 1200, and those of the other methods disclosed herein, may be separated for the sake of description, it should be understood that certain steps may be performed simultaneously or substantially simultaneously.

According to one embodiment, the method 1200 may begin as indicated by step 1202. As indicated by step 1202, advertising information for an identified advertiser may be monitored. As indicated by step 1204, a change and/or status of the advertising information for the identified advertiser may be identified. By way of example without limitation, in various embodiments, the change and/or status may correspond to one or more of: calls responsive to advertisements; missed calls; dropped calls; calls receiving busy tones; voicemail left by callers; advertisement viewings/impressions; advertisement clicks; advertisement conversions; a website, mobile app, product, etc. being ready for the advertiser's approval to have the advertiser's advertisement included in the website, mobile app, product, etc.; billing and/or account management items being identified, such as a bill coming due or past due and options to pay bills; any suitable action item requiring action or that could benefit from on the advertiser's part; any suitable need in the identified advertiser's profile and/or performance being identified; suggestions/recommendations being identified; news feed items; and/or the like.

As indicated by step 1206, the change and/or status of the advertising information for the identified advertiser may be processed. The change and/or status of the advertising information may be determined to correspond to an event of interest for the identified advertiser. For example, it may be determined that the change and/or status of the advertising information meets/exceeds a threshold condition and therefore corresponds to any event of interest to the identified advertiser. In some embodiments, the threshold condition may be pre-determined and applicable by default. In some embodiments, the threshold condition may be specified by the advertiser and stored as a preference, for instance, the notification profile repository.

As indicated by step 1208, one or more effects of the change and/or status of the advertising information for the identified advertiser may be determined. For example, the change and/or status may relate to calls responsive to advertisements, and it may be determined that certain call metrics of the identified advertiser, such a number of calls received per a certain time period, is less than average for the identified advertiser's peer group. This may be correlated to a comparison of advertisement products and/or packages that advertisers in the peer group have, generally or specifically, vis-à-vis the identified advertiser. Such correlation may reveal that the difference in call metrics may be due to a difference in advertisement products and/or packages.

As indicated by step 1210, an advertiser notification profile may be checked for the identified advertiser's preferred notification scheme, which may indicate one or more preferred methods of contact. As indicated by step 1212, the identified advertiser may be notified of the need and/or suggestion according to the advertiser's notification profile.

Referring next to FIG. 13, an exemplary environment with which embodiments may be implemented is shown with a computer system 1300 that can be used by a designer 1304 to design, for example, electronic designs. The computer system 1300 can include a computer 1302, keyboard 1322, a network router 1312, a printer 1308, and a monitor 1306. The monitor 1306, processor 1302 and keyboard 1322 are part of a computer system 1326, which can be a laptop computer, desktop computer, handheld computer, mainframe computer, etc. The monitor 1306 can be a CRT, flat screen, etc.

A designer 1304 can input commands into the computer 1302 using various input devices, such as a mouse, keyboard 1322, track ball, touch screen, etc. If the computer system 1300 comprises a mainframe, a designer 1304 can access the computer 1302 using, for example, a terminal or terminal interface. Additionally, the computer system 1326 may be connected to a printer 1308 and a server 1310 using a network router 1312, which may connect to the Internet 1318 or a WAN.

The server 1310 may, for example, be used to store additional software programs and data. In some embodiments, software implementing the systems and methods described herein can be stored on a storage medium in the server 1310. Thus, the software can be run from the storage medium in the server 1310. In another embodiment, software implementing the systems and methods described herein can be stored on a storage medium in the computer 1302. Thus, the software can be run from the storage medium in the computer system 1326. Therefore, in this embodiment, the software can be used whether or not computer 1302 is connected to network router 1312. Printer 1308 may be connected directly to computer 1302, in which case, the computer system 1326 can print whether or not it is connected to network router 1312.

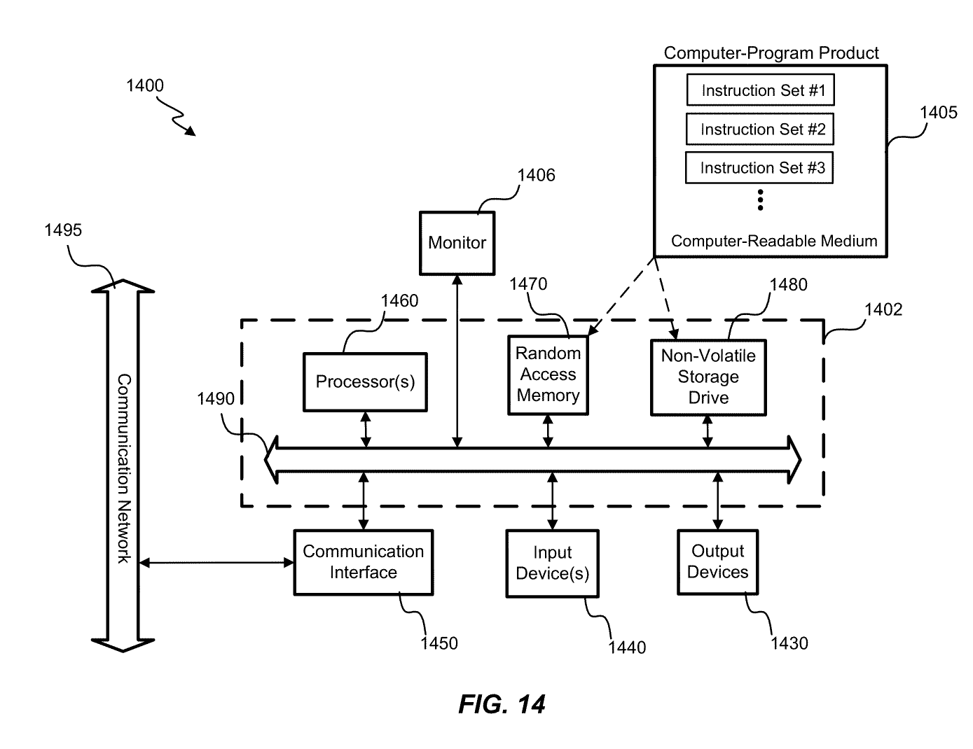

With reference to FIG. 14, an embodiment of a special-purpose computer system 1400 is shown. The above methods may be implemented by computer-program products that direct a computer system to perform the actions of the above-described methods and components. Each such computer-program product may comprise sets of instructions (codes) embodied on a computer-readable medium that directs the processor of a computer system to perform corresponding actions. The instructions may be configured to run in sequential order, or in parallel (such as under different processing threads), or in a combination thereof. After loading the computer-program products on a general purpose computer system 1326, it is transformed into the special-purpose computer system 1400.

Special-purpose computer system 1400 comprises a computer 1302, a monitor 1306 coupled to computer 1302, one or more additional user output devices 1430 (optional) coupled to computer 1302, one or more user input devices 1440 (e.g., keyboard, mouse, track ball, touch screen) coupled to computer 1302, an optional communications interface 1450 coupled to computer 1302, a computer-program product 1405 stored in a tangible computer-readable memory in computer 1302. Computer-program product 1405 directs system 1400 to perform the above-described methods. Computer 1302 may include one or more processors 1460 that communicate with a number of peripheral devices via a bus subsystem 1490. These peripheral devices may include user output device(s) 1430, user input device(s) 1440, communications interface 1450, and a storage subsystem, such as random access memory (RAM) 1470 and non-volatile storage drive 1480 (e.g., disk drive, optical drive, solid state drive), which are forms of tangible computer-readable memory.

Computer-program product 1405 may be stored in non-volatile storage drive 1480 or another computer-readable medium accessible to computer 1302 and loaded into memory 1470. Each processor 1460 may comprise a microprocessor, such as a microprocessor from Intel® or Advanced Micro Devices, Inc.®, or the like. To support computer-program product 1405, the computer 1302 runs an operating system that handles the communications of product 1405 with the above-noted components, as well as the communications between the above-noted components in support of the computer-program product 1405. Exemplary operating systems include Windows® or the like from Microsoft® Corporation, Solaris® from Oracle®, LINUX, UNIX, and the like.

User input devices 1440 include all possible types of devices and mechanisms to input information to computer system 1302. These may include a keyboard, a keypad, a mouse, a scanner, a digital drawing pad, a touch screen incorporated into the display, audio input devices such as voice recognition systems, microphones, and other types of input devices. In various embodiments, user input devices 1440 are typically embodied as a computer mouse, a trackball, a track pad, a joystick, wireless remote, a drawing tablet, a voice command system. User input devices 1440 typically allow a user to select objects, icons, text and the like that appear on the monitor 1306 via a command such as a click of a button or the like. User output devices 1430 include all possible types of devices and mechanisms to output information from computer 1302. These may include a display (e.g., monitor 1306), printers, non-visual displays such as audio output devices, etc.

Communications interface 1450 provides an interface to other communication networks 1495 and devices and may serve as an interface to receive data from and transmit data to other systems, WANs and/or the Internet 1318. Embodiments of communications interface 1450 typically include an Ethernet card, a modem (telephone, satellite, cable, ISDN), a (asynchronous) digital subscriber line (DSL) unit, a FireWire® interface, a USB® interface, a wireless network adapter, and the like. For example, communications interface 1450 may be coupled to a computer network, to a FireWire® bus, or the like. In other embodiments, communications interface 1450 may be physically integrated on the motherboard of computer 1302, and/or may be a software program, or the like.

RAM 1470 and non-volatile storage drive 1480 are examples of tangible computer-readable media configured to store data such as computer-program product embodiments of the present invention, including executable computer code, human-readable code, or the like. Other types of tangible computer-readable media include floppy disks, removable hard disks, optical storage media such as CD-ROMs, DVDs, bar codes, semiconductor memories such as flash memories, read-only-memories (ROMs), battery-backed volatile memories, networked storage devices, and the like. RAM 1470 and non-volatile storage drive 1480 may be configured to store the basic programming and data constructs that provide the functionality of various embodiments of the present invention, as described above.

Software instruction sets that provide the functionality of the present invention may be stored in RAM 1470 and non-volatile storage drive 1480. These instruction sets or code may be executed by the processor(s) 1460. RAM 1470 and non-volatile storage drive 1480 may also provide a repository to store data and data structures used in accordance with the present invention. RAM 1470 and non-volatile storage drive 1480 may include a number of memories including a main random access memory (RAM) to store of instructions and data during program execution and a read-only memory (ROM) in which fixed instructions are stored. RAM 1470 and non-volatile storage drive 1480 may include a file storage subsystem providing persistent (non-volatile) storage of program and/or data files. RAM 1470 and non-volatile storage drive 1480 may also include removable storage systems, such as removable flash memory.

Bus subsystem 1490 provides a mechanism to allow the various components and subsystems of computer 1302 communicate with each other as intended. Although bus subsystem 1490 is shown schematically as a single bus, alternative embodiments of the bus subsystem may utilize multiple busses or communication paths within the computer 1302.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

What is claimed is:

1. An advertisement information handling system to gather and provide access to advertising information for one or more advertisers, the advertisement information handling system comprising:
one or more network interfaces configured to provide access to a network;
one or more processors coupled to the one or more network interfaces to access advertising information for one or more advertisers through the network, the one or more processors to execute instructions to:
monitor for consumer activity responsive to first published content relating to an identified advertiser;
based at least in part on the monitoring, identify a first advertisement event corresponding to a first instance of consumer activity responsive to the first published content relating to the identified advertiser;
based at least in part on the monitoring, identify a second advertisement event corresponding to a second instance of consumer activity responsive to the first published content relating to the identified advertiser;
process a first set of advertising information for the identified advertiser, the first set of advertising information including information about the first advertisement event;
process a second set of advertising information for the identified advertiser, the second set of advertising information including information about the second advertisement event;
consolidate the first set of advertising information for the identified advertiser and the second set of advertising information for the identified advertiser to form a composite set of advertising information for the identified advertiser;
store the composite set of advertising information for the identified advertiser in a repository;
determine one or more advertisement metrics of the composite set of advertising information for the identified advertiser; and
enable authenticated access, to the identified advertiser via a network, to at least a portion of the composite set of advertising information for the identified advertiser, wherein the at least the portion of the composite set of advertising information is to be presented via a dashboard view;
cause indication of the one or more advertisement metrics of the composite set of advertising information for the identified advertiser, wherein the one or more advertisement metrics are to be presented in the dashboard view; and
one or more storage media coupled to the one or more processors to retain the instructions.

2. The advertisement information handling system of claim 1, wherein the first published content relating to the identified advertiser is published by a first publisher, and wherein the one or more processors are to further execute instructions to:
monitor for consumer activity responsive to second published content relating to the identified advertiser, wherein the second published content relating to the identified advertiser is to be published by a second publisher;
based at least in part on the monitoring, identify a third advertisement event corresponding to an instance of consumer activity responsive to the second published content relating to the identified advertiser;
process a third set of advertising information for the identified advertiser, the third set of advertising information including information about the third advertisement event;
consolidate the third set of advertising information for the identified advertiser into the composite set of advertising information for the identified advertiser;
determine one or more additional advertisement metrics of the composite set of advertising information for the identified advertiser; and
cause indication of the one or more additional advertisement metrics of the composite set of advertising information for the identified advertiser, wherein the one or more additional advertisement metrics are to be presented in the dashboard view.

3. The advertisement information handling system of claim 1, wherein the one or more processors are to further execute instructions to:
compare one or more items of the composite set of advertising information for the identified advertiser to reference advertising information;
identify one or more conditions at least partially based on the comparison;
access a notification profile retained for the identified advertiser;
send a notification corresponding to the identified advertiser, wherein the notification is at least partially based on:
the one or more conditions; and
the notification profile for the identified advertiser.

4. The advertisement information handling system of claim 1, wherein the one or more processors are to further execute instructions to:
compare one or more items of the composite set of advertising information for the identified advertiser to reference advertising information that comprises information about a set of one or more peer advertisers and/or information about a set of one or more publishers;
identify one or more conditions at least partially based on the comparison;
identify a recommendation for the identified advertiser based at least in part on the one or more conditions; and
cause indication of the recommendation to the identified advertiser.

5. The advertisement information handling system of claim 1, wherein one or both of the first advertisement event and/or the second advertisement event correspond to one or more of a display, a consumer communication, a consumer selection, a consumer review, a consumer rating, a consumer preference indication, and/or a conversion of a consumer to a client relationship with the identified advertiser.

6. The advertisement information handling system of claim 1, wherein the one or more processors are to further execute instructions to:
associate the identified advertiser with an advertiser category; and
identify a set of one or more peer advertisers associated with the advertiser category;
wherein the one or more advertisement metrics of the composite set of advertising information for the identified advertiser are with reference to one or more advertisement metrics of advertising information for the set of one or more peer advertisers.

7. The advertisement information handling system of claim 1, wherein the one or more processors are to further execute instructions to:
process one or more submissions from the identified advertiser, the one or more submissions at least partially defining advertising content to be directed to a set of one or more publishers for publication; and
transmit over a network the advertising content to the set of one or more publishers, and causing the set of one or more publishers to publish the advertising content.

8. A computer-implemented method for handling advertising information for one or more advertisers, the method comprising:
monitoring, by one or more computing devices, for consumer activity responsive to first published content relating to an identified advertiser;
based at least in part on the monitoring, identifying, by the one or more computing devices, a first advertisement event corresponding to a first instance of consumer activity responsive to the first published content relating to the identified advertiser;
based at least in part on the monitoring, identifying, by the one or more computing devices, a second advertisement event corresponding to a second instance of consumer activity responsive to the first published content relating to the identified advertiser;
processing, by the one or more computing devices, a first set of advertising information for the identified advertiser, the first set of advertising information including information about the first advertisement event;
processing, by the one or more computing devices, a second set of advertising information for the identified advertiser, the second set of advertising information including information about the second advertisement event;
consolidating, by the one or more computing devices, the first set of advertising information for the identified advertiser and the second set of advertising information for the identified advertiser to form a composite set of advertising information for the identified advertiser;
storing, by the one or more computing devices, the composite set of advertising information for the identified advertiser in a repository;
determining, by the one or more computing devices, one or more advertisement metrics of the composite set of advertising information for the identified advertiser; and
enabling authenticated access, to the identified advertiser via a network, to at least a portion of the composite set of advertising information for the identified advertiser, wherein the at least the portion of the composite set of advertising information is to be presented via a dashboard view; and
causing, by the one or more computing devices, indication of the one or more advertisement metrics of the composite set of advertising information for the identified advertiser, wherein the one or more advertisement metrics are to be presented in the dashboard view.

9. The computer-implemented method of claim 8, wherein the first published content relating to the identified advertiser is published by a first publisher, and the method further comprises:
monitoring for consumer activity responsive to second published content relating to the identified advertiser, wherein the second published content relating to the identified advertiser is to be published by a second publisher;
based at least in part on the monitoring, identifying a third advertisement event corresponding to an instance of consumer activity responsive to the second published content relating to the identified advertiser;
processing a third set of advertising information for the identified advertiser, the third set of advertising information including information about the third advertisement event;
consolidating the third set of advertising information for the identified advertiser into the composite set of advertising information for the identified advertiser;
determining one or more additional advertisement metrics of the composite set of advertising information for the identified advertiser; and
causing indication of the one or more additional advertisement metrics of the composite set of advertising information for the identified advertiser wherein the one or more additional advertisement metrics are to be presented in the dashboard view.

10. The computer-implemented method of claim 1, further comprising:
comparing one or more items of the composite set of advertising information for the identified advertiser to reference advertising information;
identifying one or more conditions at least partially based on the comparison;
accessing a notification profile retained for the identified advertiser;
sending a notification corresponding to the identified advertiser, wherein the notification is at least partially based on:
the one or more conditions; and
the notification profile for the identified advertiser.

11. The computer-implemented method of claim 1, the method comprising:
comparing one or more items of the composite set of advertising information for the identified advertiser to reference advertising information that comprises information about a set of one or more peer advertisers and/or information about a set of one or more publishers;
identifying one or more conditions at least partially based on the comparison;
identifying a recommendation for the identified advertiser based at least in part on the one or more conditions; and
causing indication of the recommendation to the identified advertiser.

12. The computer-implemented method of claim 1, wherein one or both of the first advertisement event and/or the second advertisement event correspond to one or more of a display, a consumer communication, a consumer selection, a consumer review, a consumer rating, a consumer preference indication, and/or a conversion of a consumer to a client relationship with the identified advertiser.

13. The computer-implemented method of claim 1, further comprising:
associating the identified advertiser with an advertiser category; and
identifying a set of one or more peer advertisers associated with the advertiser category;
wherein the one or more advertisement metrics of the composite set of advertising information for the identified advertiser are with reference to one or more advertisement metrics of advertising information for the set of one or more peer advertisers.

14. The computer-implemented method of claim 1, further comprising:
processing one or more submissions from the identified advertiser, the one or more submissions at least partially defining advertising content to be directed to a set of one or more publishers for publication; and
transmitting over a network the advertising content to the set of one or more publishers, and causing the set of one or more publishers to publish the advertising content.

15. One or more non-transitory machine-readable media having machine-readable instructions thereon which, when executed by one or more computers or other processing devices, implement a method for handling advertising information for one or more advertisers, causing the one or more computers or other processing devices to:
monitor for consumer activity responsive to first published content relating to an identified advertiser;
based at least in part on the monitoring, identify a first advertisement event corresponding to a first instance of consumer activity responsive to the first published content relating to the identified advertiser;
based at least in part on the monitoring, identify a second advertisement event corresponding to a second instance of consumer activity responsive to the first published content relating to the identified advertiser;
process a first set of advertising information for the identified advertiser, the first set of advertising information including information about the first advertisement event;
process a second set of advertising information for the identified advertiser, the second set of advertising information including information about the second advertisement event;
consolidate the first set of advertising information for the identified advertiser and the second set of advertising information for the identified advertiser to form a composite set of advertising information for the identified advertiser;
store the composite set of advertising information for the identified advertiser in a repository;
determine one or more advertisement metrics of the composite set of advertising information for the identified advertiser; and
enable authenticated access, to the identified advertiser via a network, to at least a portion of the composite set of advertising information for the identified advertiser, wherein the at least the portion of the composite set of advertising information is to be presented via a dashboard view; and
cause indication of the one or more advertisement metrics of the composite set of advertising information for the identified advertiser, wherein the one or more advertisement metrics are to be presented in the dashboard view.

16. The one or more non-transitory machine-readable media of claim 15, wherein the first published content relating to the identified advertiser is published by a first publisher, the machine-readable instructions further causing the one or more computers or other processing devices to:
monitor for consumer activity responsive to second published content relating to the identified advertiser, wherein the second published content relating to the identified advertiser is to be published by a second publisher;
based at least in part on the monitoring, identify a third advertisement event corresponding to an instance of consumer activity responsive to the second published content relating to the identified advertiser;
process a third set of advertising information for the identified advertiser, the third set of advertising information including information about the third advertisement event;
consolidate the third set of advertising information for the identified advertiser into the composite set of advertising information for the identified advertiser;
determine one or more additional advertisement metrics of the composite set of advertising information for the identified advertiser; and
cause indication of the one or more additional advertisement metrics of the composite set of advertising information for the identified advertiser wherein the one or more additional advertisement metrics are to be presented in the dashboard view.

17. The one or more non-transitory machine-readable media of claim 15, the machine-readable instructions further causing the one or more computers or other processing devices to:
compare one or more items of the composite set of advertising information for the identified advertiser to reference advertising information;
identify one or more conditions at least partially based on the comparison;
access a notification profile retained for the identified advertiser;
send a notification corresponding to the identified advertiser, wherein the notification is at least partially based on:
the one or more conditions; and
the notification profile for the identified advertiser.

18. The one or more non-transitory machine-readable media of claim 15, the machine-readable instructions further causing the one or more computers or other processing devices to:
compare one or more items of the composite set of advertising information for the identified advertiser to reference advertising information that comprises information about a set of one or more peer advertisers and/or information about a set of one or more publishers;
identify one or more conditions at least partially based on the comparison;
identify a recommendation for the identified advertiser based at least in part on the one or more conditions; and
cause indication of the recommendation to the identified advertiser.

19. The one or more non-transitory machine-readable media of claim 15, the machine-readable instructions further causing the one or more computers or other processing devices to:
associate the identified advertiser with an advertiser category; and
identify a set of one or more peer advertisers associated with the advertiser category;
wherein the one or more advertisement metrics of the composite set of advertising information for the identified advertiser are with reference to one or more advertisement metrics of advertising information for the set of one or more peer advertisers.

20. The one or more non-transitory machine-readable media of claim 15, the machine-readable instructions further causing the one or more computers or other processing devices to:
process one or more submissions from the identified advertiser, the one or more submissions at least partially defining advertising content to be directed to a set of one or more publishers for publication; and
transmit over a network the advertising content to the set of one or more publishers, and causing the set of one or more publishers to publish the advertising content.
